(19) United States
(12) Patent Application Publication
(10) Pub. No.: US 2026/0197407 A1
(43) Pub. Date: Jul. 9, 2026

(54) PRINTING APPARATUS

(71) Applicant: SEIKO EPSON CORPORATION, TOKYO (JP)

(72) Inventors: Erik HIDAYAT, Sumedang (ID); Achmad Alwan HIDAYAT, Sidoarjo (ID)

(21) Appl. No.: 19/444,433

(22) Filed: Jan. 9, 2026

(30) Foreign Application Priority Data
Jan. 9, 2025 (JP) 2025-003232

(51) Int. Cl. H04N 1/00; B41J 29/13

(52) U.S. Cl. CPC H04N 1/00535; B41J 29/13; H04N 1/00543; H04N 1/00554; H04N 1/0062

(57) ABSTRACT

A printing apparatus includes a print head, a main body case, a scanner unit including a document placement table and being pivotable about a first pivot shaft between a closed state and an open state, and a supply port cover pivotable about a second pivot shaft between a closing position where a medium supply port is closed and an opening position where the medium supply port is opened. When the scanner unit is changed from the closed state to the open state, an abutting portion of the scanner unit abuts an abutted portion of the supply port cover, whereby the supply port cover moves from the closing position to the opening position.

The present application is based on, and claims priority from JP Application Serial Number 2025-003232, filed January 9, 2025, the disclosure of which is hereby incorporated by reference herein in its entirety.

### BACKGROUND

### 1. Technical Field

The present disclosure relates to a printing apparatus.

### 2. Related Art

A multifunction peripheral including a scanner unit and a printer unit has been known. The multifunction peripheral is an example of a printing apparatus. A multifunction peripheral disclosed in JP-A-2015-67401 includes a housing of a scanner unit, a housing of a printer unit, and a pivoting member as an interlocking mechanism. A document cover is pivotally provided at the housing of the scanner unit. The housing of the scanner unit pivots with respect to the housing of the printer unit. When the housing of the scanner unit pivots with respect to the housing of the printer unit, the pivoting member pivots. When the pivoting member pivots, a tray cover, which is an example of a supply port cover, pivots to open a sheet insertion port. The pivoting member includes an abutted portion, an abutting portion, a torsion coil spring, and the like.

JP-A-2015-67401 is an example of the related art.

The interlocking mechanism that opens the tray cover in conjunction with the pivot of the scanner unit includes a plurality of components and a complicated mechanism, and it is difficult to reduce the number of components.

### SUMMARY

According to an aspect of the present disclosure, there is provided a printing apparatus including: a print head configured to perform printing on a medium; a main body case accommodating the print head; a scanner unit including a document placement table on which a document is to be placed, the scanner unit being pivotable about a first pivot shaft between a closed state of having the main body case closed and an open state of having the main body case open; a conveyance path provided in the main body case and configured to allow the medium to be conveyed from a medium supply port formed in the main body case to a facing position facing the print head; and a supply port cover pivotable about a second pivot shaft with respect to the main body case between a closing position where the medium supply port is closed and an opening position where the medium supply port is opened. The medium supply port is provided in a first direction of the document placement table in a plan view. The first pivot shaft and the second pivot shaft extend along an intersecting axis intersecting the first direction. The second pivot shaft is located in the first direction of the first pivot shaft. When the scanner unit is in the closed state and the supply port cover is in the closing position, a part of the supply port cover overlaps an upper surface of the scanner unit. When the scanner unit is changed from the closed state to the open state, an abutting portion provided at the scanner unit abuts an abutted portion provided at the supply port cover, whereby the supply port cover moves from the closing position to the opening position.

### BRIEF DESCRIPTION OF THE DRAWINGS

FIG. 1 shows an external configuration of a printer.

FIG. 2 shows the external configuration of the printer.

FIG. 3 shows the external configuration of the printer.

FIG. 4 shows the external configuration of the printer.

FIG. 5 shows a schematic configuration of the printer.

FIG. 6 shows a schematic configuration of the printer.

FIG. 7 shows a schematic configuration of the printer.

FIG. 8 shows a schematic configuration of the printer.

FIG. 9 shows a schematic configuration of the printer.

FIG. 10 shows a schematic configuration of the printer.

FIG. 11 shows a schematic configuration of the printer.

FIG. 12 is a cross-sectional view of the printer.

FIG. 13 is a cross-sectional view of the printer.

FIG. 14 is a cross-sectional view of the printer.

FIG. 15 shows a schematic configuration of the printer.

FIG. 16 shows a schematic configuration of the printer.

FIG. 17 shows a schematic configuration of the printer.

FIG. 18 shows a schematic configuration of the printer.

FIG. 19 shows a schematic configuration of an image reading unit support base.

FIG. 20 shows a schematic configuration of the image reading unit support base.

FIG. 21 shows a schematic configuration of the image reading unit support base.

FIG. 22 shows a schematic configuration of a supply path cover.

FIG. 23 shows a schematic configuration of the supply path cover.

FIG. 24 shows a schematic configuration of the supply path cover.

FIG. 25 shows a schematic configuration of the printer.

FIG. 26 shows a schematic configuration of the printer.

FIG. 27 shows a schematic configuration of the printer.

### DESCRIPTION OF EMBODIMENTS

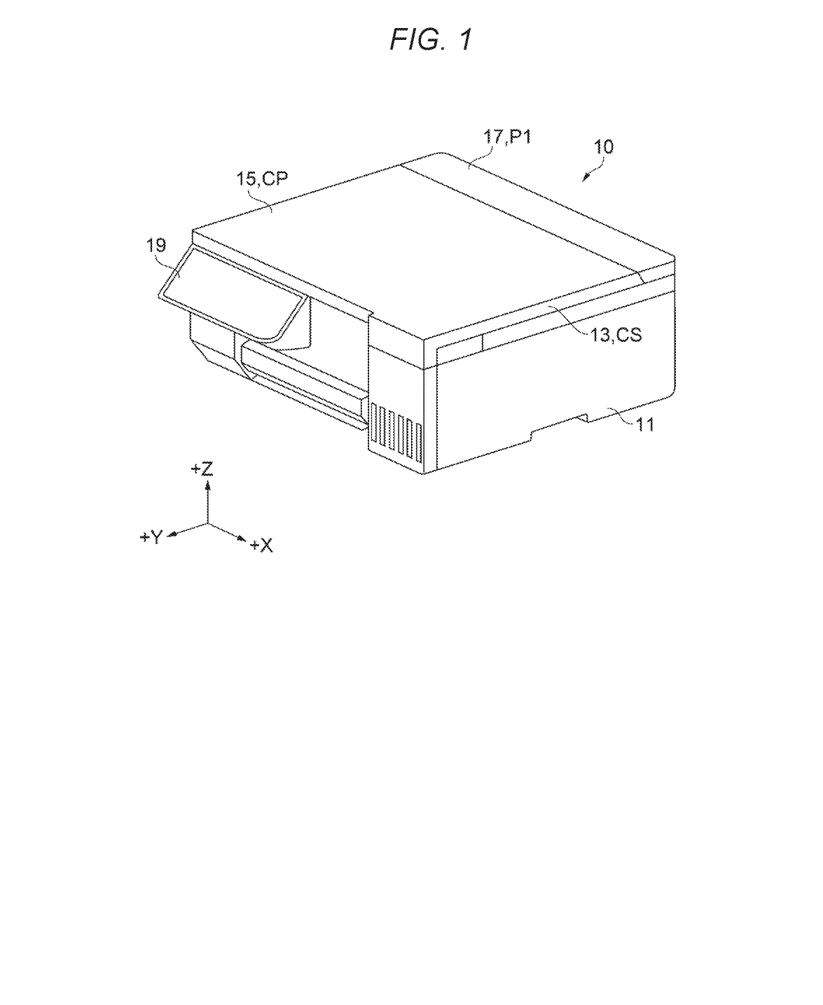

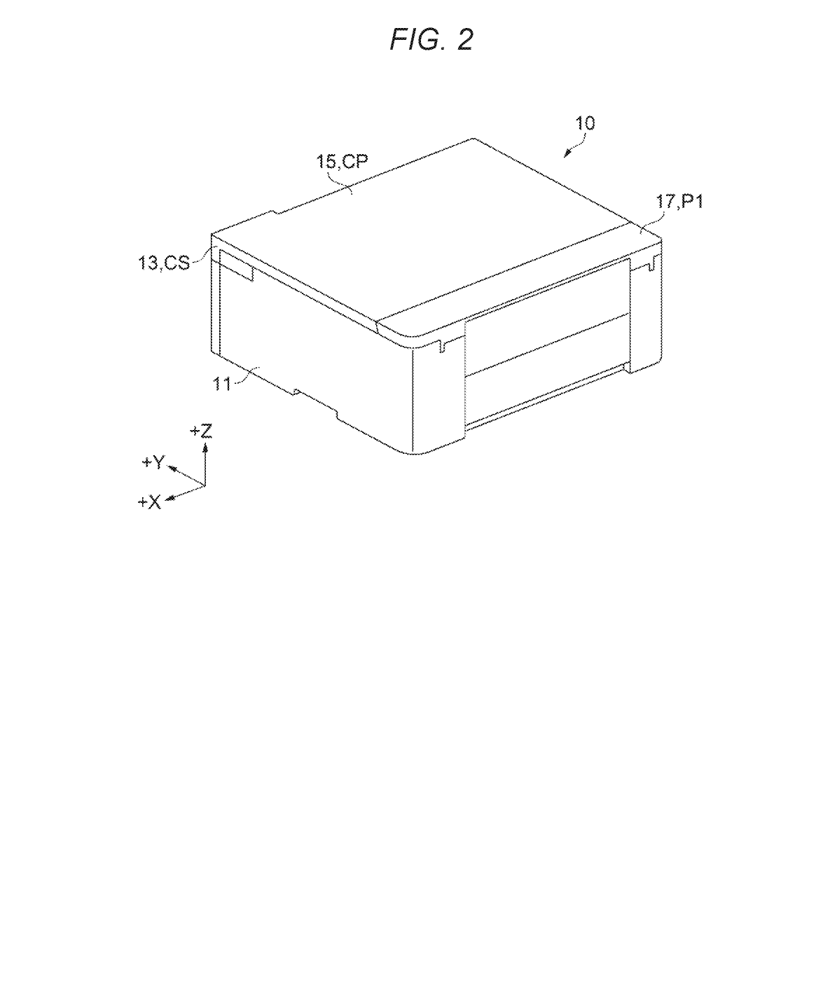

FIGS. 1 and 2 show an external configuration of a printer 10. The printer 10 is a multifunction peripheral having a reading function of reading a document and a printing function of performing printing on a medium. The printer 10 may have a facsimile function of transmitting a facsimile, and the like. The printer 10 is an inkjet printer that performs printing by ejecting ink onto a medium. The printer 10 corresponds to an example of a printing apparatus. FIG. 1 is a perspective view of the printer 10 as viewed from a front side. FIG. 2 is a perspective view of the printer 10 as viewed from a rear side.

Multiple drawings including FIG. 1 show an XYZ coordinate system. A Z axis is an axis perpendicular to an installation surface of the printer 10. A +Z direction is a direction upward from the installation surface. A -Z direction is a direction from above toward the installation surface. An X axis is an axis perpendicular to the Z axis. The X axis is an axis along an image reading unit pivot shaft 13R described later. An +X direction is a direction from left to right when the printer 10 is viewed from a facing position facing a front surface having a control panel 19 described later. A -X direction is a direction from right to left when the printer 10 is viewed from the facing position. A Y axis is an axis perpendicular to the X axis and the Z axis. A +Y direction is a direction from a rear surface to the front surface of the printer 10. The front surface is a surface having the control panel 19. The rear surface is a surface opposite to the front surface. A -Y direction is a direction from the front surface to the rear surface of the printer 10.

As illustrated in FIGS. 1 and 2, the printer 10 includes a printer case 11, an image reading unit 13, a document table cover 15, a supply path cover 17, and the control panel 19.

The printer case 11 is a housing that accommodates a conveyance unit 30, a recording unit 60 including a recording head 62, and the like. The conveyance unit 30, the recording head 62, and the recording unit 60 will be described later. The printer case 11 corresponds to an example of a main body case. The printer case 11 pivotally supports the image reading unit 13 and the supply path cover 17.

The image reading unit 13 reads a document. The image reading unit 13 corresponds to an example of a scanner unit. The image reading unit 13 is disposed in a position in the +Z direction of the printer case 11. The image reading unit 13 is configured to be pivotable between a shielded state CS and an open state OS with respect to the printer case 11. The shielded state CS is a state in which the image reading unit 13 closes and shields the printer case 11. The shielded state CS corresponds to an example of a closed state. In the shielded state CS, the image reading unit 13 closes the printer case 11. The open state OS is a state in which the image reading unit 13 opens the printer case 11 and opens an inside of the printer case 11. The open state OS corresponds to an example of an open state. In the open state OS, the image reading unit 13 opens the printer case 11. The image reading unit 13 pivotally supports the document table cover 15. FIGS. 1 and 2 illustrate the image reading unit 13 in the shielded state CS.

The document table cover 15 covers a surface of the image reading unit 13 in the +Z direction. The document table cover 15 corresponds to an example of a document cover. The document table cover 15 is disposed in a position in the +Z direction of the image reading unit 13. The document table cover 15 is configured to be pivotable between a contact position CP and a separation position SP with respect to the image reading unit 13. The contact position CP is a position where the document table cover 15 contacts a document table 23 and shields the document table 23. The contact position CP corresponds to an example of a shielding position. The separation position SP is a position where the document table cover 15 is separated from the document table 23 and the document table 23 is open. The separation position SP corresponds to an example of an opening position. FIGS. 1 and 2 illustrate the document table cover 15 in the contact position CP.

The supply path cover 17 covers a supply port 51 described later. The supply path cover 17 corresponds to an example of a supply port cover. The supply path cover 17 is disposed at a position in the -Y direction and the +Z direction of the printer case 11. The supply path cover 17 is configured to be pivotable between a first position P1 and a second position P2. The first position P1 is a position where the supply path cover 17 closes the supply port 51, and is a position where supply of a medium from the supply port 51 by a user is hindered. The first position P1 corresponds to an example of a closing position. The second position P2 is a position where the supply path cover 17 opens the supply port 51, and is a position where the user can supply the medium into the printer case 11. The second position P2 corresponds to an example of an opening position. FIGS. 1 and 2 show the supply path cover 17 in the first position P1.

The control panel 19 receives an input operation by the user. The control panel 19 displays various types of information. The control panel 19 includes a display panel, input buttons, and the like. The display panel may have a touch input function. The control panel 19 is provided on a surface of the printer 10 in the +Y direction.

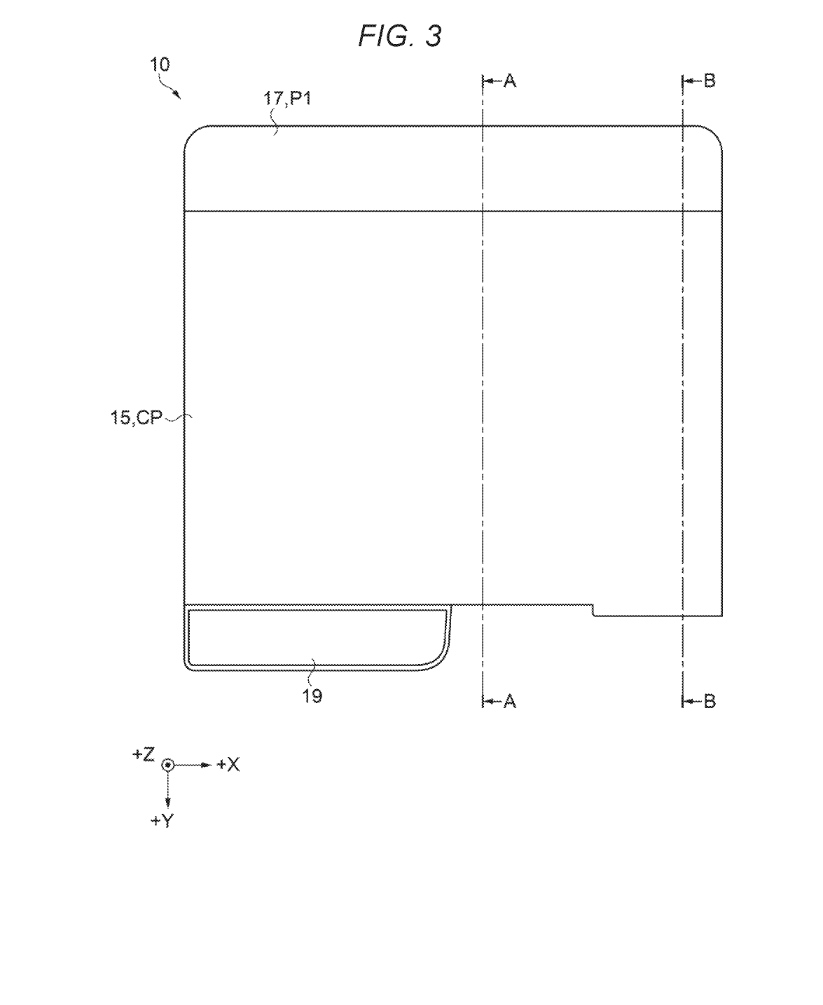

FIG. 3 shows the external configuration of the printer 10. FIG. 3 shows the printer 10 in a plan view from the +Z direction. FIG. 3 shows the document table cover 15, the supply path cover 17, and the control panel 19. FIG. 3 shows the document table cover 15 in the contact position CP. FIG. 3 shows the supply path cover 17 in the first position P1.

The supply path cover 17 is provided at a position in the -Y direction of the document table cover 15 in the plan view from the +Z direction. The -Y direction corresponds to an example of a first direction. The document table cover 15 and the supply path cover 17 cover the image reading unit 13, and the image reading unit 13 is not viewed in the plan view from the +Z direction.

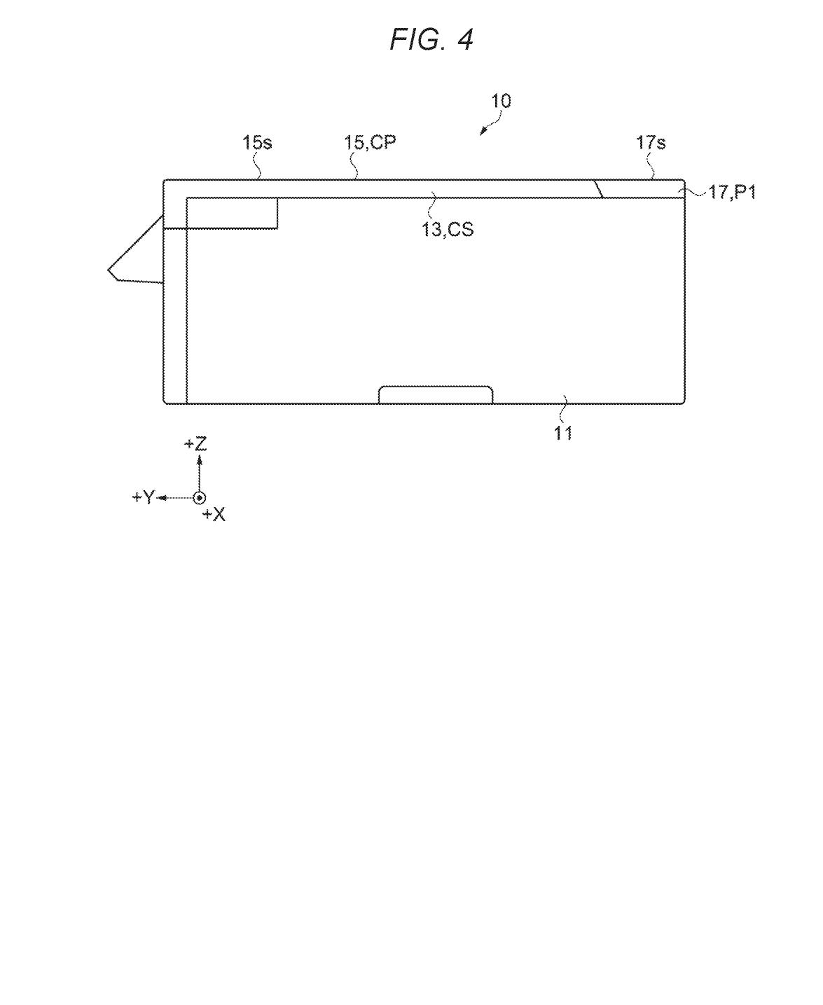

FIG. 4 shows the external configuration of the printer 10. FIG. 4 shows the printer 10 as viewed from the +X direction. FIG. 4 shows the printer case 11, the image reading unit 13, the document table cover 15, and the supply path cover 17. FIG. 4 shows the image reading unit 13 in the shielded state CS. FIG. 4 shows the document table cover 15 in the contact position CP. FIG. 4 shows the supply path cover 17 in the first position P1.

FIG. 4 shows a document table cover upper surface 15s and a supply path cover upper surface 17s. The document table cover upper surface 15s is a surface of the document table cover 15 in the +Z direction. The document table cover upper surface 15s corresponds to an example of a document cover upper surface. The supply path cover upper surface 17s is a surface of the supply path cover 17 in the +Z direction. The supply path cover upper surface 17s corresponds to an example of a supply port cover upper surface.

A height position of the document table cover upper surface 15s along the Z axis is the same or substantially the same as a height position of the supply path cover upper surface 17s along the Z axis. The supply path cover upper surface 17s and the document table cover upper surface 15s are located on the same plane. The supply path cover upper surface 17s and the document table cover upper surface 15s are in a state without a step. Since the supply path cover upper surface 17s and the document table cover upper surface 15s are located on the same plane, the design of the printer 10 is improved.

The supply path cover upper surface 17s of the supply path cover 17 in the first position P1 and the document table cover upper surface 15s of the document table cover 15 in the contact position CP are preferably located on the same plane.

Since the supply path cover upper surface 17s and the document table cover upper surface 15s are located on the same plane, the design of the printer 10 is improved.

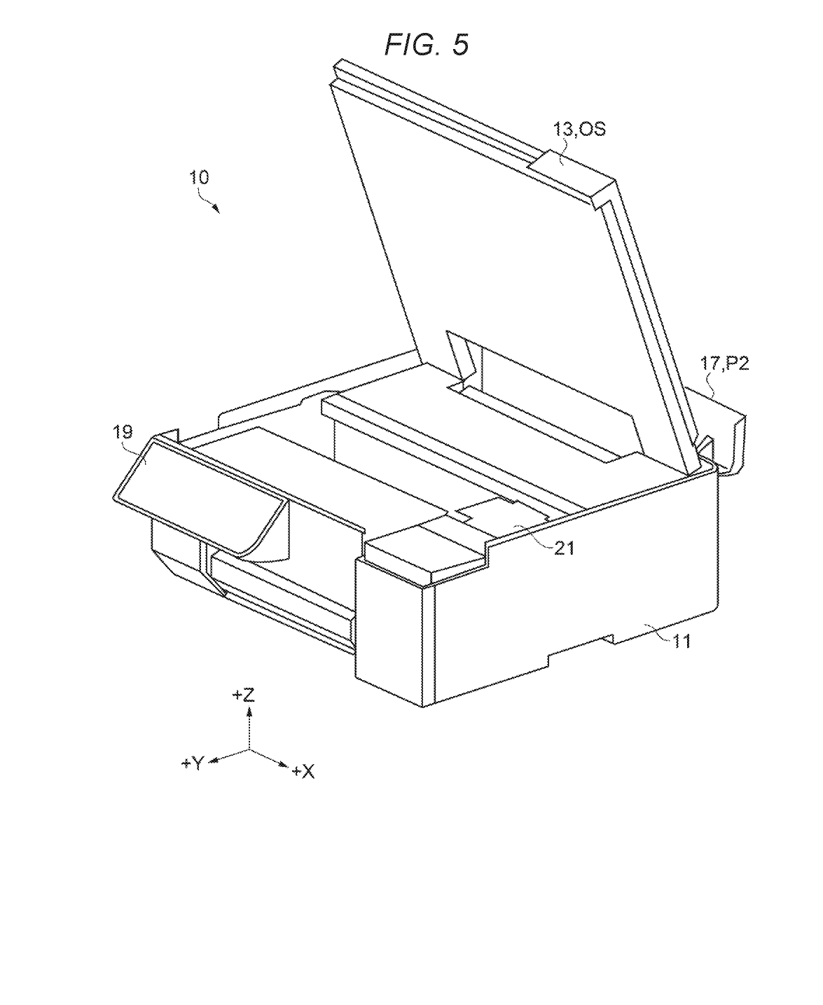

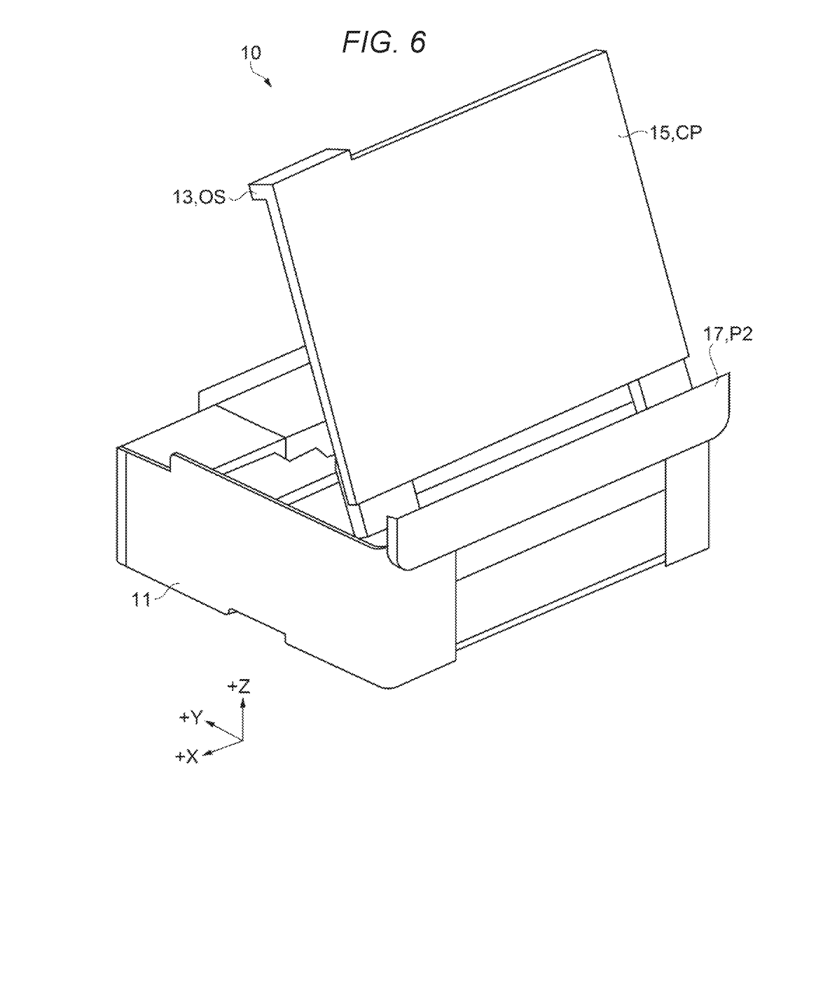

FIGS. 5 and 6 show a schematic configuration of the printer 10. FIGS. 5 and 6 show the printer 10 of which the image reading unit 13 is changed to the open state OS by the user. FIG. 5 is a perspective view of the printer 10 as viewed from the front side, of which the image reading unit 13 is in the open state OS. FIG. 6 is a perspective view of the printer 10 as viewed from the rear side, of which the image reading unit 13 is in the open state OS. When the image reading unit 13 is in the open state OS, the user can access the inside of the printer case 11.

FIG. 5 schematically shows the inside of the printer case 11. An ink holding portion 21 and the like are accommodated inside the printer case 11. When the image reading unit 13 is in the open state OS, the user can access the ink holding portion 21, for example.

The ink holding portion 21 holds one or more types of ink. When the printer 10 has an ink replenishment configuration of an ink cartridge type, the ink holding portion 21 holds one or more ink cartridges. The user can replace the ink cartridge when the image reading unit 13 is in the open state OS. When the printer 10 has an ink replenishment configuration of a continuous ink supply system (CISS), the ink holding portion 21 holds one or more ink containers. The user can supply ink to the ink container when the image reading unit 13 is in the open state OS.

When the image reading unit 13 enters the open state OS, the supply path cover 17 moves from the first position P1 to the second position P2 in conjunction with the image reading unit 13. When the user changes the image reading unit 13 from the shielded state CS to the open state OS, the supply path cover 17 moves from the first position P1 to the second position P2. As shown in FIGS. 5 and 6, when the image reading unit 13 is in the open state OS, the supply path cover 17 is in the second position P2. A mechanism by which the image reading unit 13 moves the supply path cover 17 will be described later.

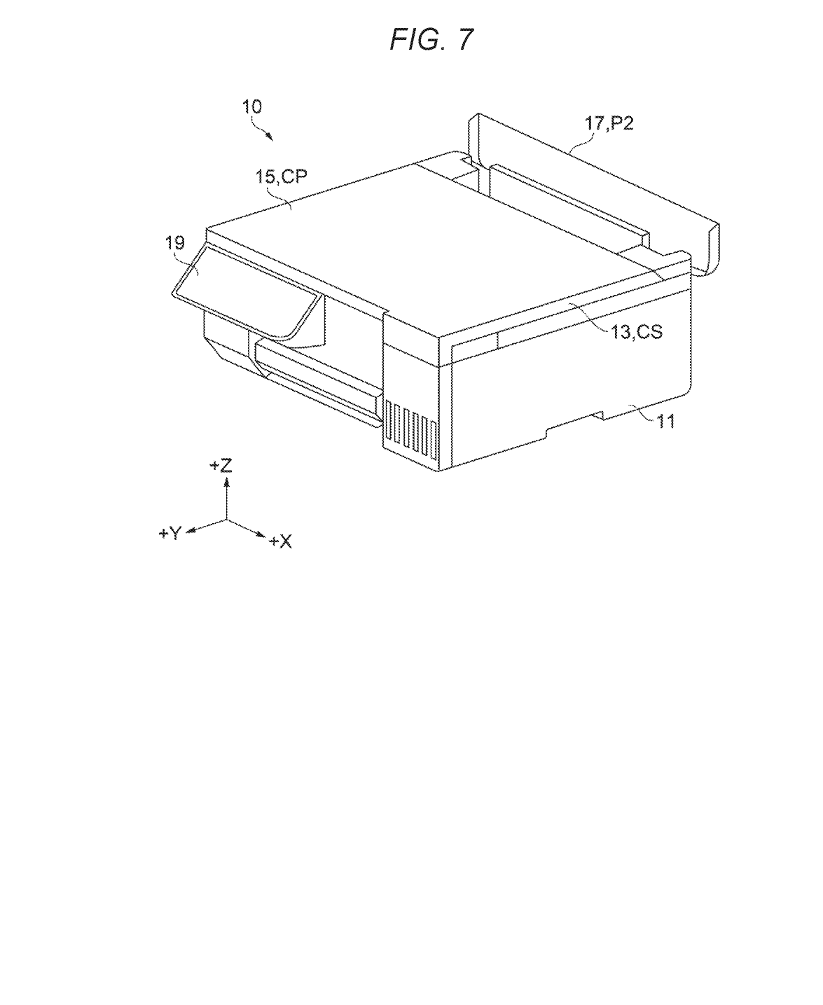

FIG. 7 shows a schematic configuration of the printer 10. FIG. 7 shows the printer 10 of which the supply path cover 17 is moved to the second position P2 by the user. FIG. 7 is a perspective view of the printer 10 as viewed from the front side, of which the supply path cover 17 is in the second position P2.

The supply path cover 17 is opened and closed by a user operation. The supply path cover 17 moves from the first position P1 to the second position P2 or from the second position P2 to the first position P1 by the user operation. When the supply path cover 17 is moved to the second position P2, the user can set the medium in the supply port 51. When the medium is set in the supply port 51, the supply path cover 17 functions as a guide member that supports the medium. The supply path cover 17 is movable from the first position P1 to the second position P2 when the document table cover 15 is in the contact position CP and the image reading unit 13 is in the shielded state CS.

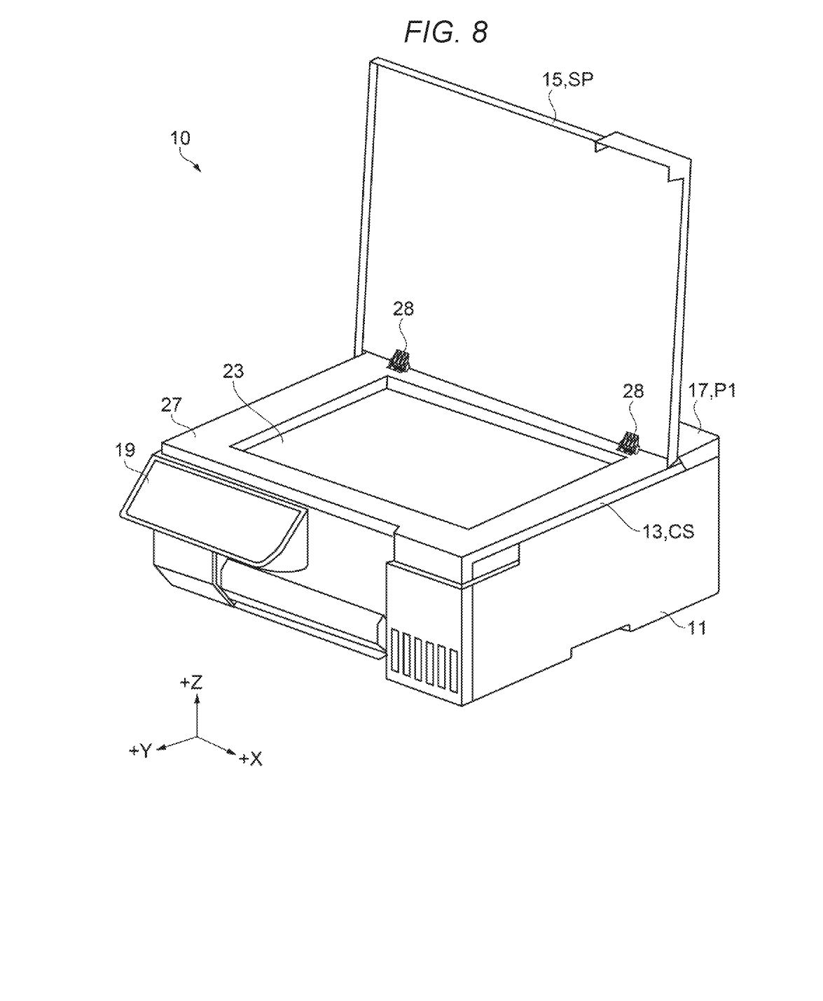

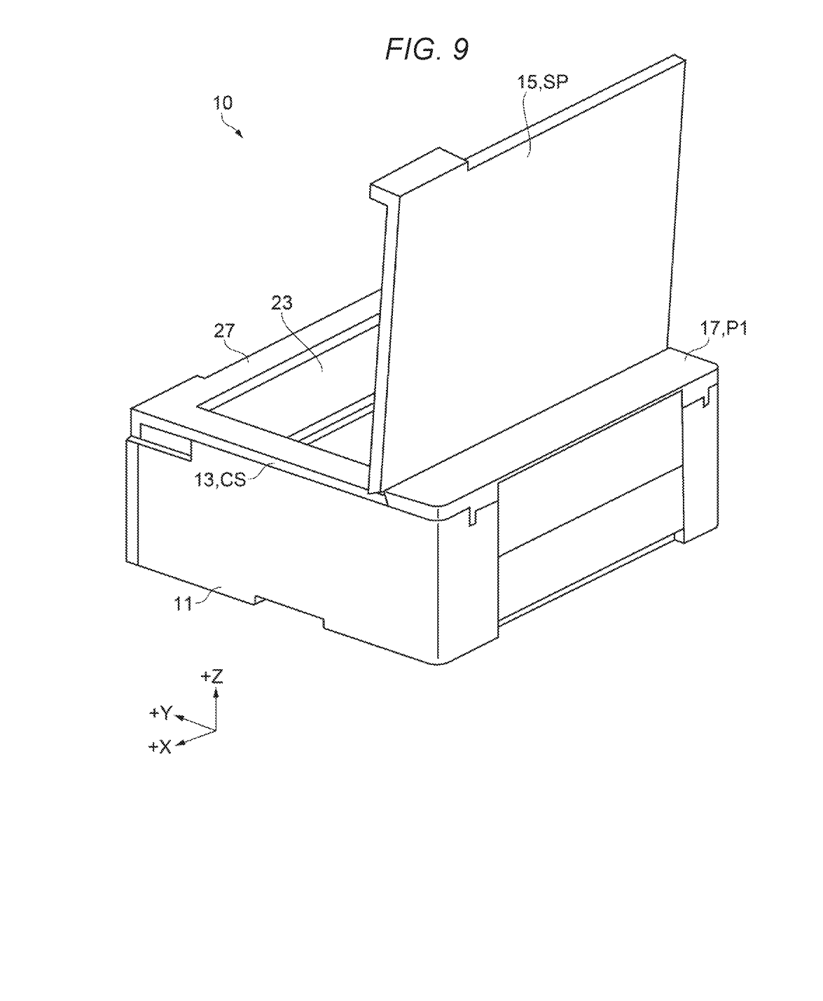

FIGS. 8 and 9 show a schematic configuration of the printer 10. FIGS. 8 and 9 show the printer 10 of which the document table cover 15 is moved to the separation position SP by the user. FIG. 8 is a perspective view of the printer 10 as viewed from the front side, of which the document table cover 15 is in the separation position SP. FIG. 9 is a perspective view of the printer 10 as viewed from the rear side, of which the document table cover 15 is in the separation position SP.

FIG. 8 shows the document table 23, an image reading unit housing 27, and a document table cover support portion 28. The image reading unit 13 includes the document table 23, the image reading unit housing 27, and the document table cover support portion 28.

A document is to be placed on the document table 23. The document table 23 corresponds to an example of a document placement table. As an example, the document table 23 is made of glass that can transmit light. The document table 23 is shielded or opened by the document table cover 15. When the document table cover 15 is moved to the separation position SP, the user can place the document on the document table 23. The document placed on the document table 23 is read by a sensor unit (not shown). The document table 23 is supported by the image reading unit housing 27.

The sensor unit reads the document placed on the document table 23 and generates read data. The sensor unit includes, for example, a contact image sensor module (CISM). The CISM includes a substrate, a light emitting diode (LED) array, a lens array, and the like. The sensor unit is disposed at a position in the -Z direction of the document table 23. The sensor unit is configured to be movable along the document table 23. The sensor unit reads the document via the document table 23.

The image reading unit housing 27 supports the document table 23, the sensor unit, and the like. The image reading unit housing 27 corresponds to an example of a scanner housing. The image reading unit housing 27 is disposed at an outer periphery of the document table 23 and surrounds the document table 23. A detailed configuration of the image reading unit housing 27 will be described later.

The document table cover 15 is pivotally attached to the image reading unit 13 by the document table cover support portion 28. The document table cover support portion 28 is provided at the image reading unit housing 27. The document table cover support portion 28 includes a hinge or the like. As an example, the document table cover 15 is detachably attached by the document table cover support portion 28 by snap-fitting. Although FIG. 8 shows two document table cover support portions 28, the present disclosure is not limited thereto. The image reading unit 13 includes one or more document table cover support portions 28.

The document table cover 15 is opened and closed by a user operation. The document table cover 15 moves from the contact position CP to the separation position SP or from the separation position SP to the contact position CP by the user operation. When the document table cover 15 is moved to the separation position SP, the user can place the document on the document table 23. The document table cover 15 is movable from the contact position CP to the separation position SP when the supply path cover 17 is in the first position P1 and the image reading unit 13 is in the shielded state CS.

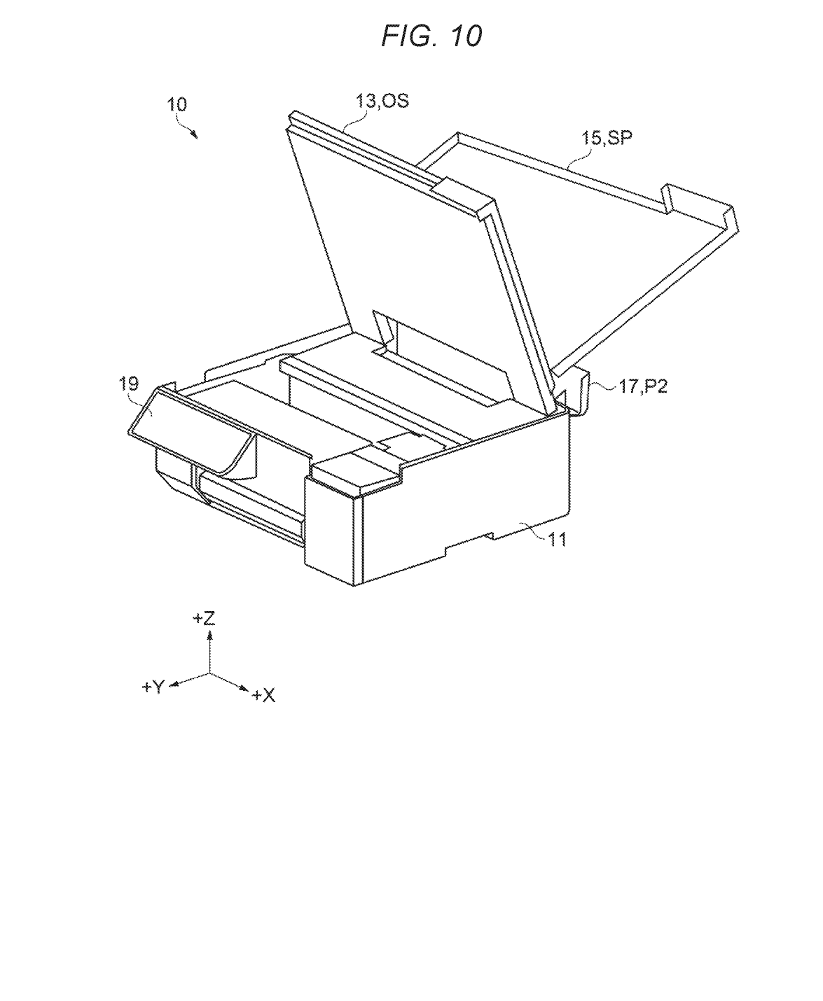

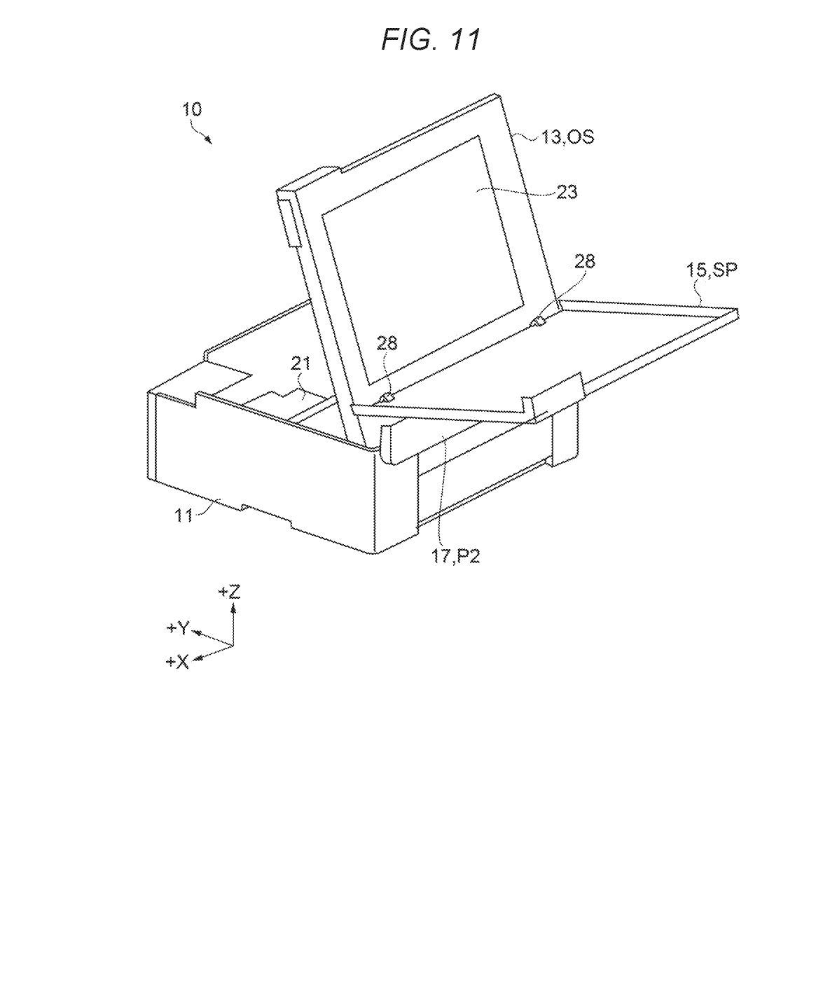

FIGS. 10 and 11 show a schematic configuration of the printer 10. FIGS. 10 and 11 show the printer 10 of which the image reading unit 13 is changed to the open state OS by the user in a state where the document table cover 15 is in the separation position SP. FIG. 10 is a perspective view of the printer 10 as viewed from the front side, of which the image reading unit 13 is changed to the open state OS by the user. FIG. 11 is a perspective view of the printer 10 as viewed from the rear side, of which the image reading unit 13 is changed to the open state OS by the user.

The user can change the state of the image reading unit 13 from the shielded state CS to the open state OS when the document table cover 15 is in the separation position SP. The image reading unit 13 changes to the shielded state CS or the open state OS according to a user operation without being affected by the position of the document table cover 15. When the image reading unit 13 changes from the shielded state CS to the open state OS, the supply path cover 17 moves from the first position P1 to the second position P2 without being affected by the position of the document table cover 15.

The document table cover 15 in the separation position SP shown in FIGS. 10 and 11 does not contact the supply path cover 17. The separation position SP of the document table cover 15 may vary depending on a configuration of the document table cover support portion 28, an operation method of the image reading unit 13 by the user, and the like. When the separation position SP of the document table cover 15 varies, the supply path cover 17 in the second position P2 comes into contact with the document table cover 15 and supports the document table cover 15. The supply path cover 17 is provided at a position where the supply path cover 17 in the second position P2 can abut the document table cover 15. Since the supply path cover 17 supports the document table cover 15, it is possible to prevent the document table cover 15 from pivoting further than expected. When the document table cover 15 is attached to the image reading unit 13 by snap-fitting, the supply path cover 17 can prevent the document table cover 15 from being detached from the image reading unit 13.

When the image reading unit 13 is in the open state OS and the document table cover 15 is in the separation position SP, it is preferable that the supply path cover 17 in the first position P1 can abut the document table cover 15.

Since the supply path cover 17 supports the document table cover 15, it is possible to prevent the document table cover 15 from pivoting further than expected.

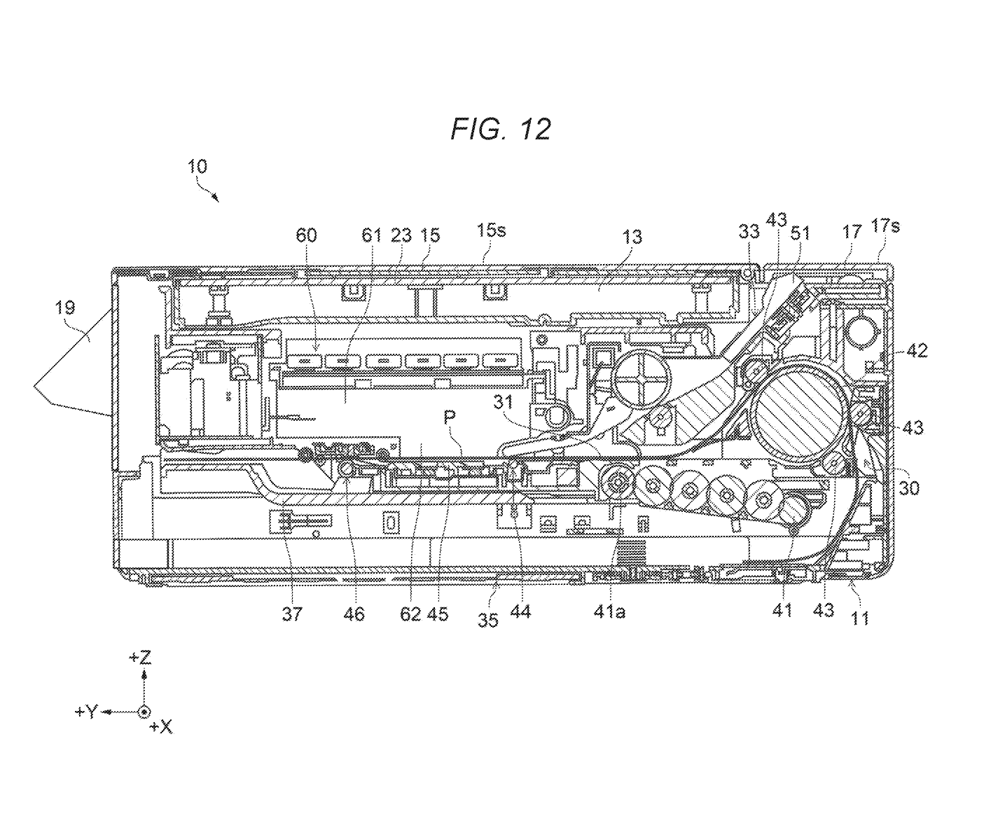

FIG. 12 shows a cross-sectional configuration of the printer 10. FIG. 12 shows a cross section taken along A-A shown in FIG. 3. FIG. 12 shows a cross section of the printer case 11, the document table cover 15, and the supply path cover 17. FIG. 12 shows an internal configuration of the printer case 11. The printer case 11 accommodates the conveyance unit 30 and the recording unit 60.

The conveyance unit 30 conveys the medium in the printer case 11. The conveyance unit 30 includes a first conveyance path 31, a second conveyance path 33, a cassette 35, and a paper discharge tray 37.

The first conveyance path 31 is provided in the printer case 11. The first conveyance path 31 is a path for conveying the medium from the cassette 35 to the paper discharge tray 37. A pickup roller 41, a reversing roller 42, a plurality of driven rollers 43, a conveyance roller pair 44, a medium guide member 45, and a discharge roller pair 46 are disposed along the first conveyance path 31.

The pickup roller 41 picks up the medium placed in the cassette 35 and guides the medium to the first conveyance path 31. The pickup roller 41 is disposed at a position in the +Z direction of the cassette 35. The pickup roller 41 is configured to be pivotable about a pickup roller pivot shaft 41a as a fulcrum. The pickup roller 41 comes into contact with or separates from the medium placed in the cassette 35 by pivoting about the pickup roller pivot shaft 41a as a fulcrum.

The reversing roller 42 conveys the medium, which is conveyed into the first conveyance path 31 by the pickup roller 41, toward the conveyance roller pair 44. When the printer 10 performs duplex printing on the medium, the reversing roller 42 reverses the front and back of the medium that is conveyed toward the reversing roller 42 by the conveyance roller pair 44, and conveys the medium toward the conveyance roller pair 44 again.

The plurality of driven rollers 43 are disposed along a circumferential surface of the reversing roller 42. Each of the plurality of driven rollers 43 nips the medium with the reversing roller 42 and conveys the medium. The driven roller 43 is driven to rotate according to rotation of the reversing roller 42. Although FIG. 12 shows three driven rollers 43, the present disclosure is not limited thereto. The number of the driven rollers 43 is appropriately set.

The conveyance roller pair 44 conveys the medium toward the medium guide member 45 or the reversing roller 42. The conveyance roller pair 44 conveys the medium moving along the first conveyance path 31 and the second conveyance path 33. The conveyance roller pair 44 nips the medium and transmits a driving force. The conveyance roller pair 44 conveys the medium by transmitting the driving force.

The medium guide member 45 supports the medium conveyed by the conveyance roller pair 44. The medium guide member 45 is disposed at a position facing the recording unit 60. The medium guide member 45 is disposed at a position in the -Z direction of the recording unit 60. The medium supported by the medium guide member 45 is subjected to printing by the recording head 62 of the recording unit 60. The recording head 62 will be described later.

The discharge roller pair 46 conveys the medium subjected to printing by the recording unit 60 toward the paper discharge tray 37. The discharge roller pair 46 nips the medium and transmits a driving force. The discharge roller pair 46 conveys the medium by transmitting the driving force. The discharge roller pair 46 is disposed at a position in the +Y direction of the medium guide member 45.

The second conveyance path 33 is provided in the printer case 11. The second conveyance path 33 is a path from the supply port 51 to the conveyance roller pair 44. The medium conveyed through the second conveyance path 33 is conveyed to a printing position P facing the recording head 62 via the conveyance roller pair 44. The second conveyance path 33 corresponds to an example of a conveyance path.

The supply port 51 is an opening through which the medium is supplied. The supply port 51 corresponds to an example of a medium supply port. The supply port 51 is formed in the printer case 11. The supply port 51 is provided at a position in the -Y direction and the +Z direction of the printer 10. One or more media are set in the supply port 51. The supply port 51 is opened and closed by the supply path cover 17. When the supply path cover 17 opens the supply port 51, the user can set the medium in the supply port 51.

The cassette 35 accommodates the medium. The cassette 35 is provided at a position in the -Z direction of the printer 10. The cassette 35 is configured to be slidable along the Y axis by a user operation. When the cassette 35 is moved in the +Y direction, the user can place the medium in the cassette 35. When the cassette 35 is moved in the -Y direction, the medium accommodated in the cassette 35 can come into contact with the pickup roller 41.

The medium subjected to printing by the recording head 62 is placed on the paper discharge tray 37. The paper discharge tray 37 is configured to be switchable between an accommodated state and an expanded state. The accommodated state is a state in which the paper discharge tray 37 is accommodated in the printer case 11. The expanded state is a state in which the paper discharge tray 37 has moved in the +Y direction and moved to the outside of the printer case 11. FIG. 12 shows the paper discharge tray 37 in the accommodated state.

The recording unit 60 performs printing on the medium. The recording unit 60 is disposed at a position in the +Z direction of the medium guide member 45. The recording unit 60 includes a carriage 61 and the recording head 62.

The carriage 61 supports the ink holding portion 21 and the recording head 62, and moves the recording head 62 along the X axis. The carriage 61 moves the recording head 62 in the +X direction or the -X direction along the X axis. The carriage 61 moves the recording head 62 above the medium supported by the medium guide member 45.

The recording head 62 performs printing on the medium by ejecting ink. The recording head 62 corresponds to an example of a print head. The recording head 62 ejects the ink held by the ink holding portion 21 onto the medium. The recording head 62 performs printing on the medium by ejecting the ink onto the medium supported at the printing position P facing the recording head 62. The medium supported at the printing position P is conveyed along the first conveyance path 31 or the second conveyance path 33. The printing position P corresponds to an example of a facing position.

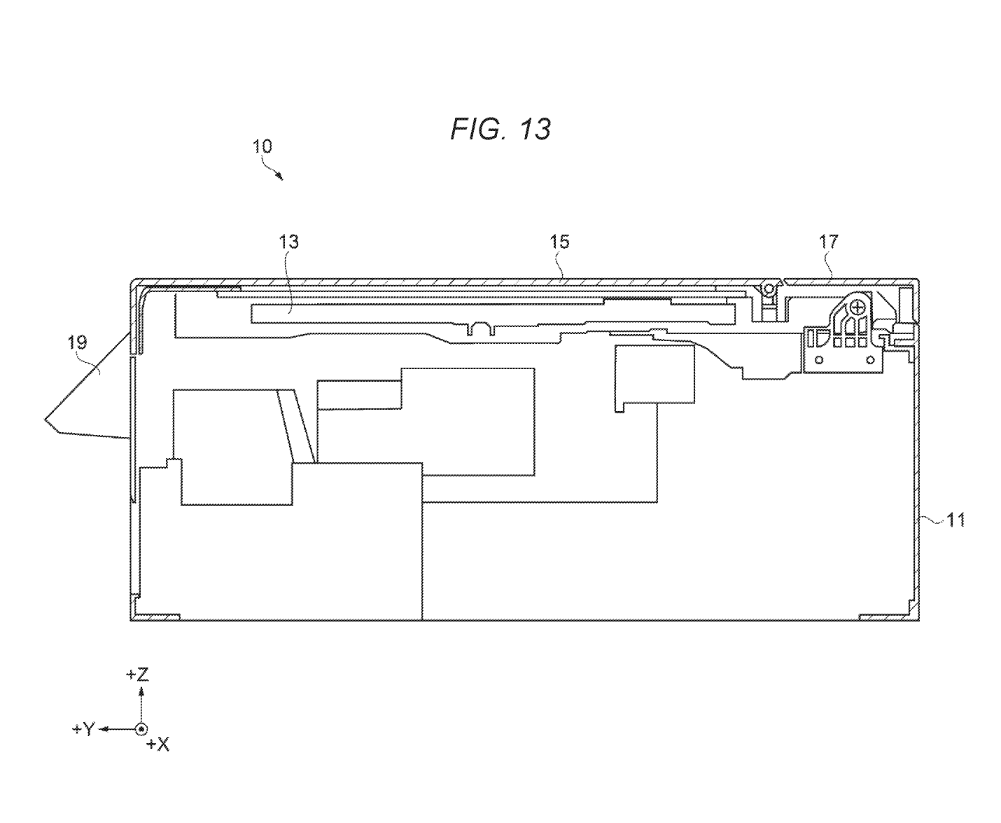

FIG. 13 shows a cross-sectional configuration of the printer 10. FIG. 13 shows a cross section taken along B-B shown in FIG. 3. FIG. 13 shows a cross section of the printer case 11, the document table cover 15, and the supply path cover 17. FIG. 13 shows the image reading unit 13 in the shielded state CS. FIG. 13 shows the document table cover 15 in the contact position CP. FIG. 13 shows the supply path cover 17 in the first position P1. FIG. 13 shows the internal configuration of the printer case 11 and an internal configuration of the image reading unit 13.

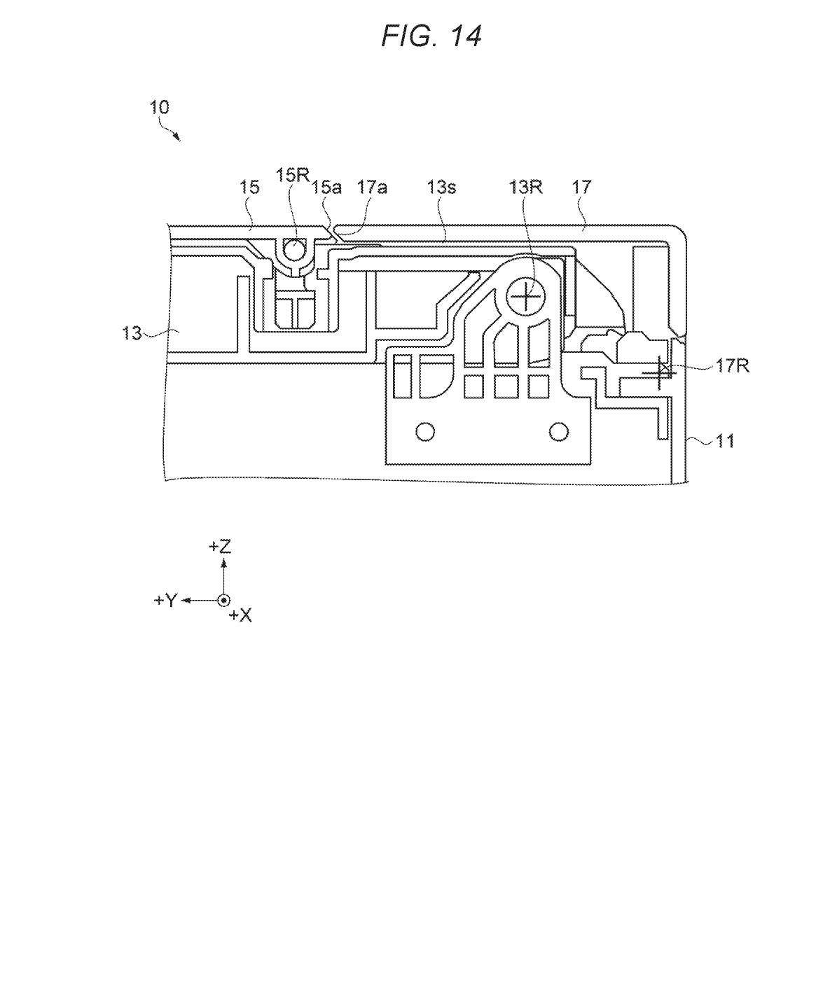

FIG. 14 shows a cross-sectional configuration of the printer 10. FIG. 14 shows the cross section taken along B-B shown in FIG. 3. FIG. 14 shows, in an enlarged manner, the vicinity of the supply path cover 17 shown in FIG. 13. FIG. 14 shows the image reading unit 13 in the shielded state CS. FIG. 14 shows the document table cover 15 in the contact position CP. FIG. 14 shows an image reading unit upper surface 13s, a document table cover side end portion 15a, and a supply path cover side end portion 17a. FIG. 14 shows the supply path cover 17 in the first position P1. FIG. 14 shows the image reading unit pivot shaft 13R, a document table cover pivot shaft 15R, and a supply path cover pivot shaft 17R. FIG. 14 virtually shows the image reading unit pivot shaft 13R and the supply path cover pivot shaft 17R.

The image reading unit upper surface 13s is a surface of the image reading unit 13 in the +Z direction. The image reading unit upper surface 13s corresponds to an example of an upper surface of the scanner unit. When the supply path cover 17 is in the first position P1, a part of the supply path cover 17 overlaps the image reading unit upper surface 13s. When a part of the supply path cover 17 overlaps the image reading unit upper surface 13s, the supply path cover 17 opens and closes according to the displacement of the image reading unit 13.

The document table cover side end portion 15a is an end surface of the document table cover 15 in the -Y direction. The document table cover side end portion 15a corresponds to an example of a document cover end portion. The document table cover side end portion 15a faces the supply path cover side end portion 17a. As an example, the document table cover side end portion 15a is formed of an inclined surface as shown in FIG. 14.

The supply path cover side end portion 17a is an end surface of the supply path cover 17 in the +Y direction. The supply path cover side end portion 17a corresponds to an example of a supply port cover end portion. The supply path cover side end portion 17a faces the document table cover side end portion 15a. As an example, the supply path cover side end portion 17a is formed of an inclined surface as shown in FIG. 14. The supply path cover side end portion 17a is provided at a position overlapping the document table cover side end portion 15a from above the document table cover side end portion 15a as the inclined surface.

The supply path cover side end portion 17a of the supply path cover 17 in the first position P1 and the document table cover side end portion 15a of the document table cover 15 in the contact position CP may or may not be in contact with each other. The supply path cover side end portion 17a and the document table cover side end portion 15a are preferably in contact with each other. Since the supply path cover side end portion 17a and the document table cover side end portion 15a are in contact with each other, a foreign matter such as dust is less likely to enter between the supply path cover 17 and the document table cover 15.

The supply path cover side end portion 17a in the +Y direction of the supply path cover 17 in the first position P1 and the document table cover side end portion 15a in the -Y direction of the document table cover 15 in the contact position CP are preferably in contact with each other.

A foreign matter such as dust is less likely to enter between the supply path cover 17 and the document table cover 15.

The image reading unit pivot shaft 13R is a pivot center of the image reading unit 13. The image reading unit pivot shaft 13R corresponds to an example of a first pivot shaft. The image reading unit pivot shaft 13R extends along the X axis intersecting the Y axis extending along the -Y direction. The X axis corresponds to an example of an intersecting axis. The image reading unit 13 pivots about the image reading unit pivot shaft 13R and changes to the shielded state CS and the open state OS with respect to the printer case 11. A part of the image reading unit 13 is provided at a position in the -Z direction of the supply path cover 17. The image reading unit pivot shaft 13R is provided at the position in the -Z direction of the supply path cover 17.

The document table cover pivot shaft 15R is a pivot center of the document table cover 15. The document table cover pivot shaft 15R corresponds to an example of a third pivot shaft. The document table cover pivot shaft 15R extends along the X axis intersecting the Y axis extending along the -Y direction. The document table cover 15 pivots about the document table cover pivot shaft 15R and pivots to the contact position CP and the separation position SP with respect to the image reading unit 13. The document table cover pivot shaft 15R is provided at a position in the +Y direction of the image reading unit pivot shaft 13R. The +Y direction corresponds to an example of a second direction. The document table cover 15 can be opened and closed without being affected by the state of the image reading unit 13.

The supply path cover pivot shaft 17R is a pivot center of the supply path cover 17. The supply path cover pivot shaft 17R corresponds to an example of a second pivot shaft. The supply path cover pivot shaft 17R extends along the X axis intersecting the Y axis extending along the -Y direction. The supply path cover 17 pivots about the supply path cover pivot shaft 17R and pivots to the first position P1 and the second position P2 with respect to the supply port 51. The supply path cover pivot shaft 17R is provided at a position in the -Y direction and the -Z direction of the image reading unit pivot shaft 13R.

The image reading unit 13 includes the document table cover 15 that is pivotable about the document table cover pivot shaft 15R between the contact position CP where the document table 23 is covered and the separation position SP where the document table 23 is opened. The document table cover pivot shaft 15R extends along the X axis and is located in the +Y direction, which is opposite to the -Y direction, of the image reading unit pivot shaft 13R. The supply path cover 17 is provided in the -Y direction of the document table cover 15 in a plan view from the +Z direction.

The document table cover 15 can be opened and closed by the user without requiring the image reading unit 13 or the supply path cover 17 to be opened or closed.

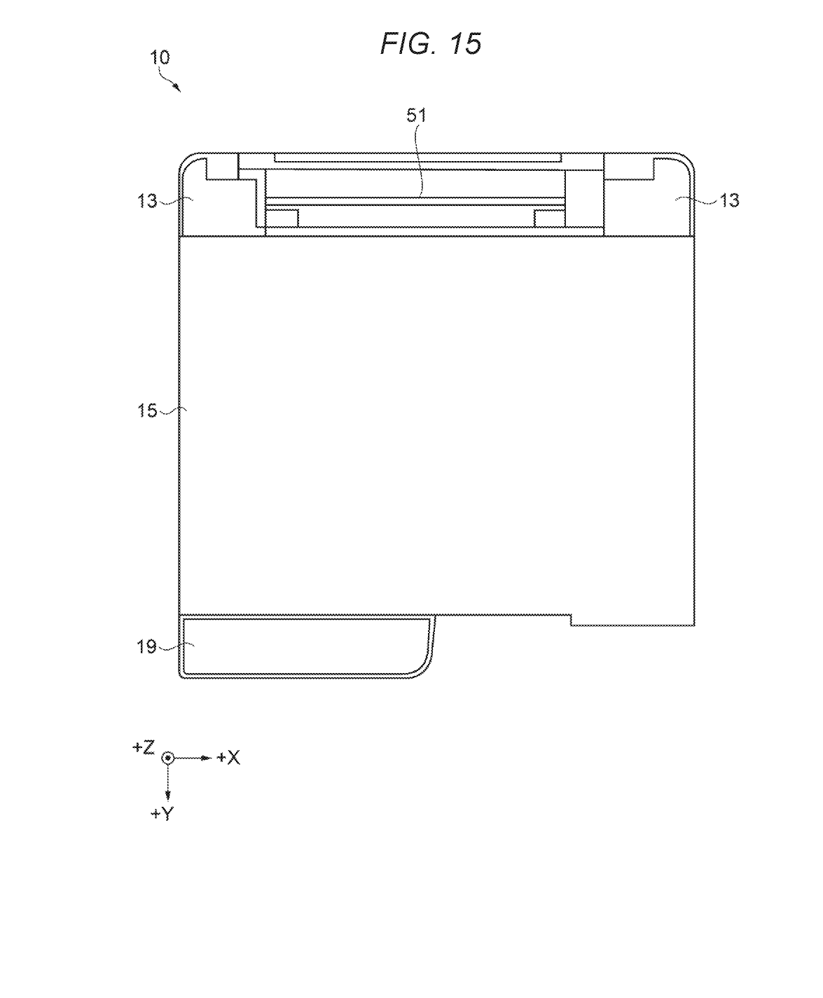

FIG. 15 shows a schematic configuration of the printer 10. FIG. 15 shows the printer 10 in a plan view from the +Z direction. FIG. 15 shows the printer 10 with the supply path cover 17 removed. FIG. 15 shows the image reading unit 13 in the shielded state CS. FIG. 15 shows the document table cover 15 in the contact position CP. When the supply path cover 17 is removed, the supply port 51 is exposed, and the supply port 51 is visually recognized in the plan view from the +Z direction.

The supply port 51 extends along the X axis. A part of the image reading unit 13 is provided at a position in the +X direction and a position in the -X direction of the supply port 51. The supply port 51 is provided at a position sandwiched by the image reading unit 13.

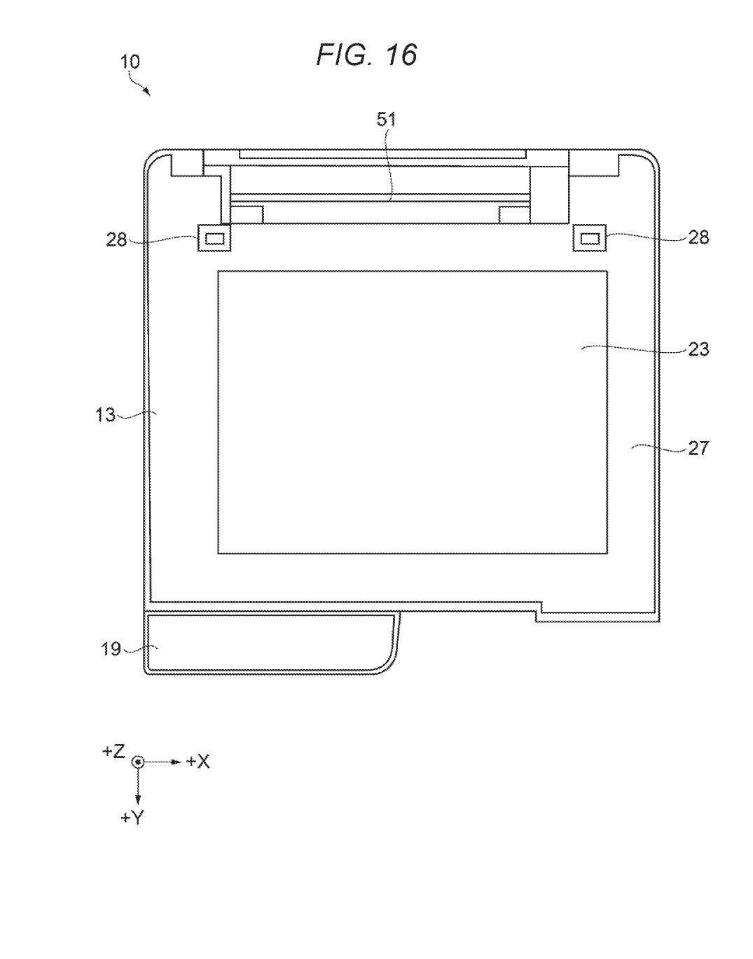

FIG. 16 shows a schematic configuration of the printer 10. FIG. 16 shows the printer 10 in a plan view from the +Z direction. FIG. 16 shows the printer 10 with the document table cover 15 and the supply path cover 17 removed. FIG. 16 shows the image reading unit 13 in the shielded state CS. When the document table cover 15 and the supply path cover 17 are removed, the document table 23 and the supply port 51 are exposed. The document table 23 and the supply port 51 are visually recognized in the plan view from the +Z direction.

The document table 23 and the supply port 51 are disposed along the Y axis. The supply port 51 is provided at a position in the -Y direction of the document table 23. A width of the supply port 51 along the X axis is shorter than a width of the document table 23 along the X axis.

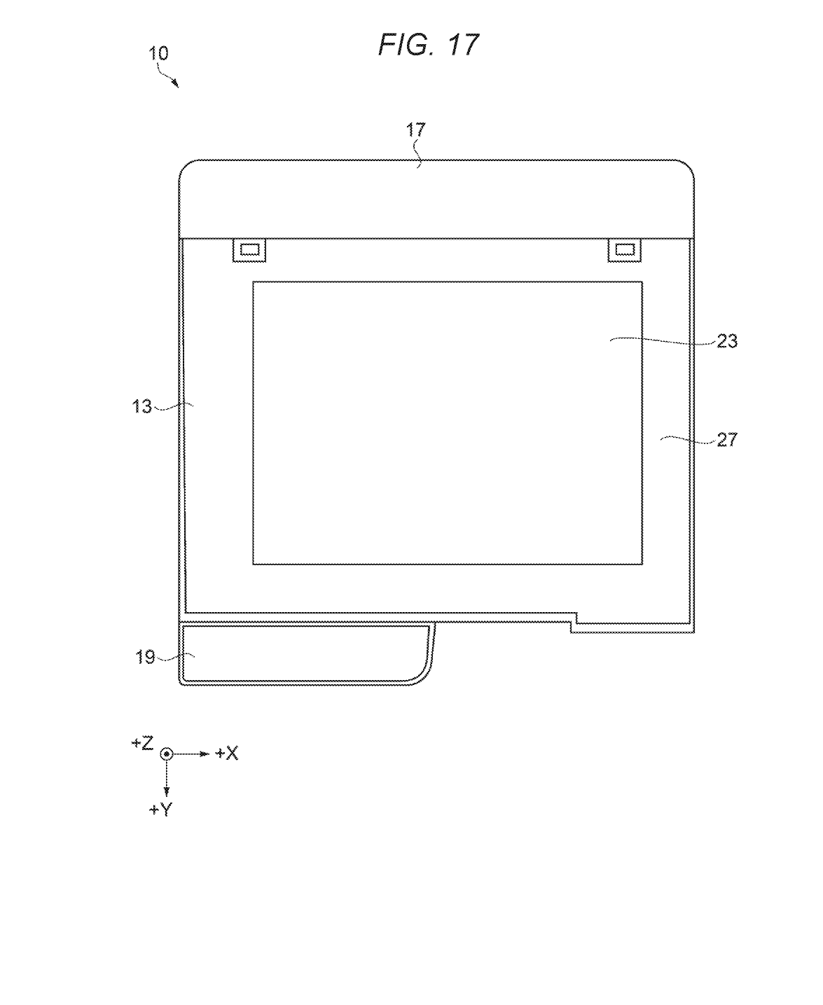

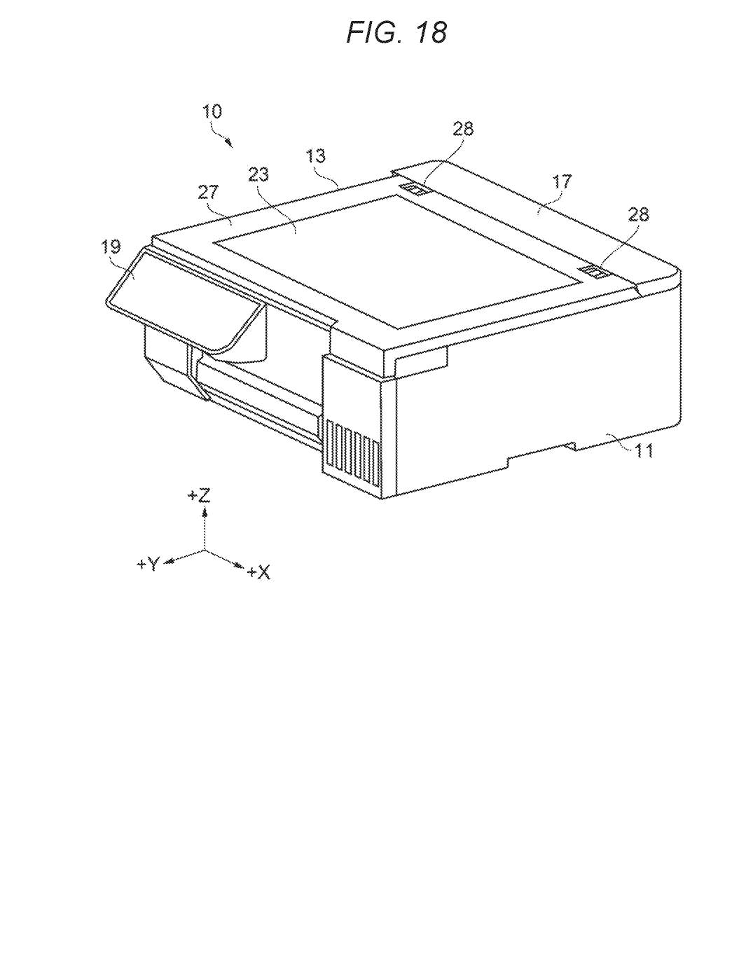

FIGS. 17 and 18 show a schematic configuration of the printer 10. FIGS. 17 and 18 show the printer 10 with the document table cover 15 removed. FIGS. 17 and 18 show the image reading unit 13 in the shielded state CS. FIGS. 17 and 18 show the supply path cover 17 in the first position P1. When the document table cover 15 is removed, the document table 23 is exposed. The document table 23 is visually recognized in a plan view from the +Z direction. FIG. 17 shows the printer 10 in the plan view from the +Z direction. FIG. 18 is a perspective view of the printer 10 as viewed from the front side.

As illustrated in FIGS. 16, 17, and 18, the supply path cover 17 covers a part of the image reading unit 13. A portion of the image reading unit 13 at a position in the +X direction of the supply port 51 and a portion of the image reading unit 13 at a position in the -X direction of the supply port 51 are covered by the supply path cover 17.

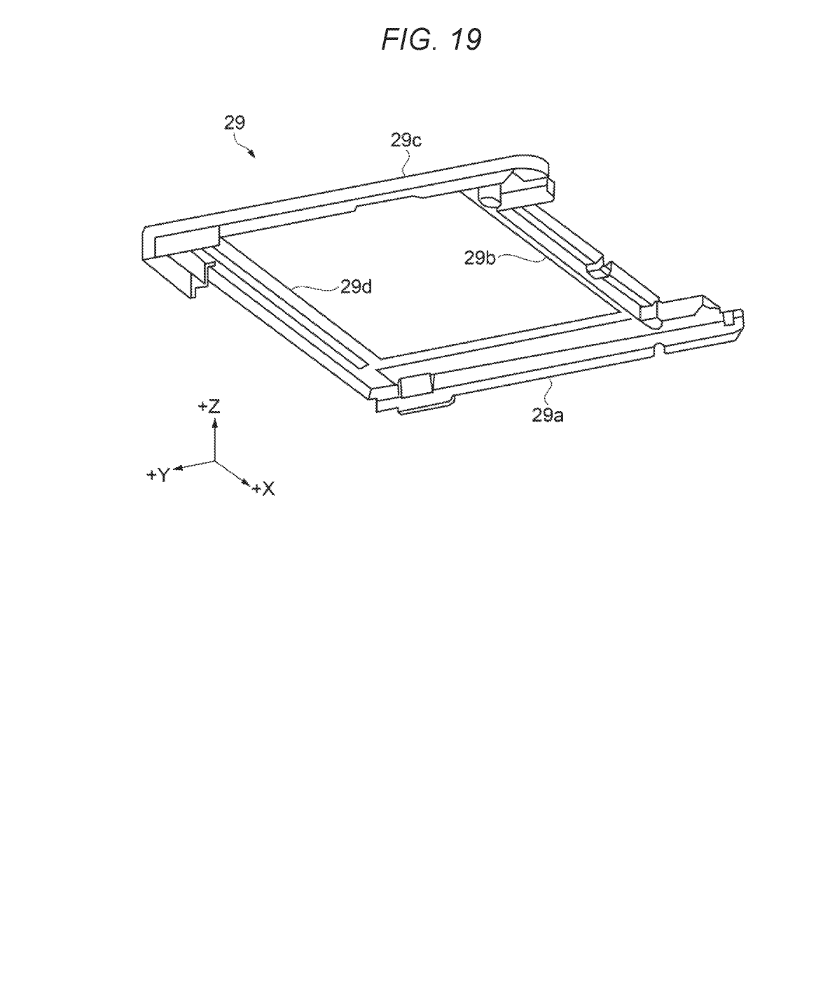

FIG. 19 shows a schematic configuration of an image reading unit support base 29. FIG. 19 is a perspective view of the image reading unit support base 29 as viewed from the +Z direction. The image reading unit support base 29 is one of the members constituting the image reading unit housing 27. The image reading unit housing 27 includes the image reading unit support base 29. The image reading unit support base 29 includes a first frame member 29a, a second frame member 29b, a third frame member 29c, and a fourth frame member 29d.

The first frame member 29a is provided at a position in the +X direction of the image reading unit support base 29. The first frame member 29a extends along the Y axis. The first frame member 29a is coupled to the second frame member 29b and the fourth frame member 29d.

The second frame member 29b is provided at a position in the -Y direction of the image reading unit support base 29. The second frame member 29b extends along the X axis. The second frame member 29b is coupled to the first frame member 29a and the third frame member 29c.

The third frame member 29c is provided at a position in the -X direction of the image reading unit support base 29. The third frame member 29c extends along the Y axis. The third frame member 29c is provided parallel or substantially parallel to the first frame member 29a. The third frame member 29c is coupled to the second frame member 29b and the fourth frame member 29d.

The fourth frame member 29d is provided at a position in the +Y direction of the image reading unit support base 29. The fourth frame member 29d extends along the X axis. The fourth frame member 29d is provided parallel or substantially parallel to the second frame member 29b. The fourth frame member 29d is coupled to the first frame member 29a and the third frame member 29c.

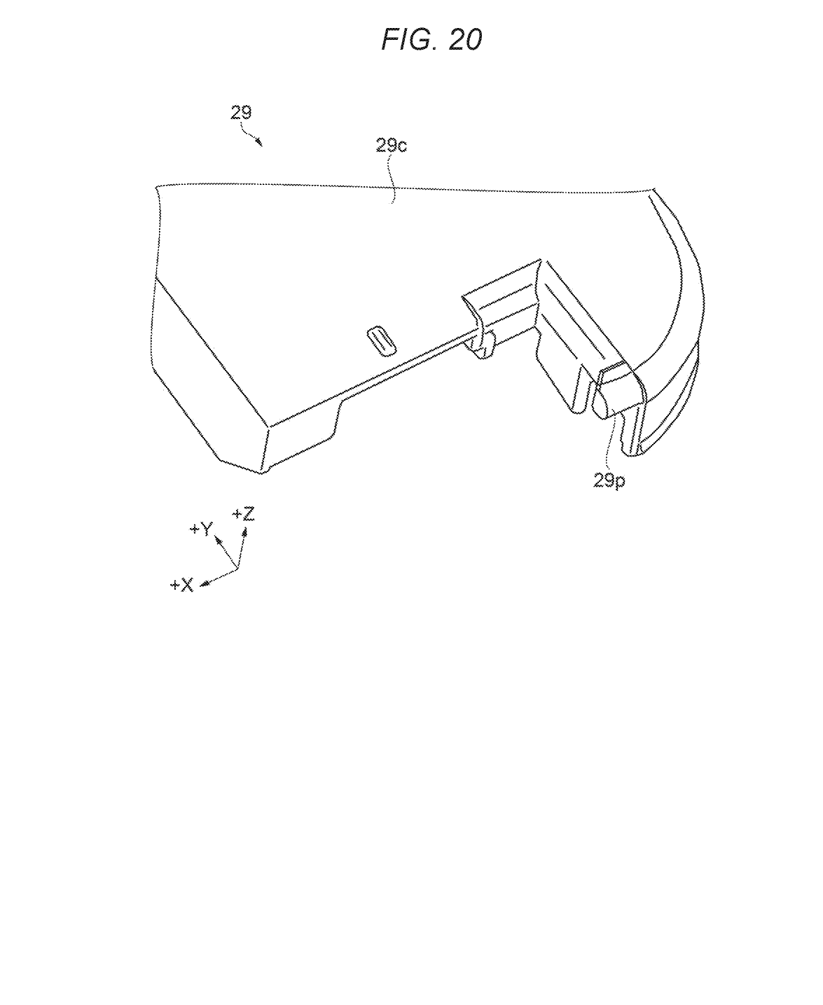

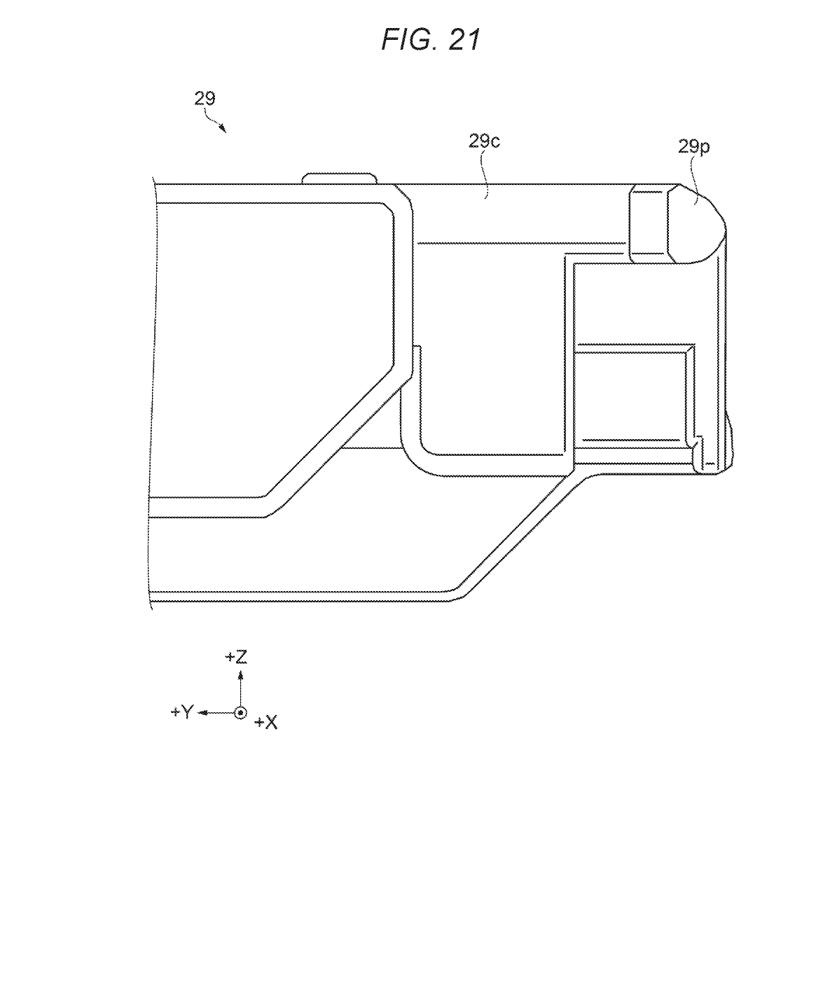

FIGS. 20 and 21 show a schematic configuration of the image reading unit support base 29. FIGS. 20 and 21 show a part of the image reading unit support base 29 in an enlarged manner. FIGS. 20 and 21 show an end portion of the third frame member 29c in the -Y direction in an enlarged manner. FIG. 20 is a perspective view of the end portion of the third frame member 29c in the -Y direction as viewed from the +Z direction. FIG. 21 is an external view of the end portion of the third frame member 29c in the -Y direction as viewed from the +X direction. Although not shown in FIGS. 20 and 21, an end portion of the first frame member 29a in the -Y direction may have the same configuration as or a different configuration from the end portion of the third frame member 29c in the -Y direction.

A pressing portion 29p is provided at the end portion of the third frame member 29c in the -Y direction. The pressing portion 29p presses the supply path cover 17. The pressing portion 29p corresponds to an example of an abutting portion. The pressing portion 29p is provided at the image reading unit 13 including the image reading unit housing 27 including the image reading unit support base 29. The pressing portion 29p may be formed integrally with the image reading unit housing 27 or may be formed separately. The pressing portion 29p is preferably formed integrally with the image reading unit housing 27. When the pressing portion 29p is integrally formed with the image reading unit housing 27, the occurrence of a pivot failure of the supply path cover 17 during pivot of the image reading unit 13 is reduced.

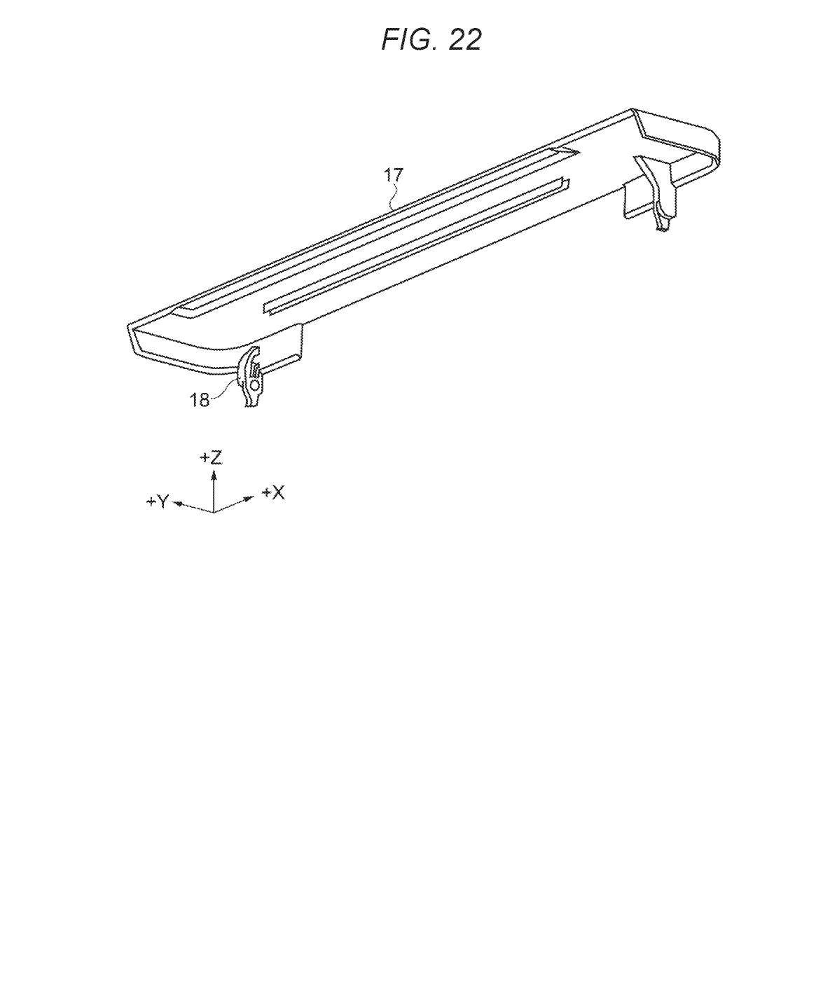

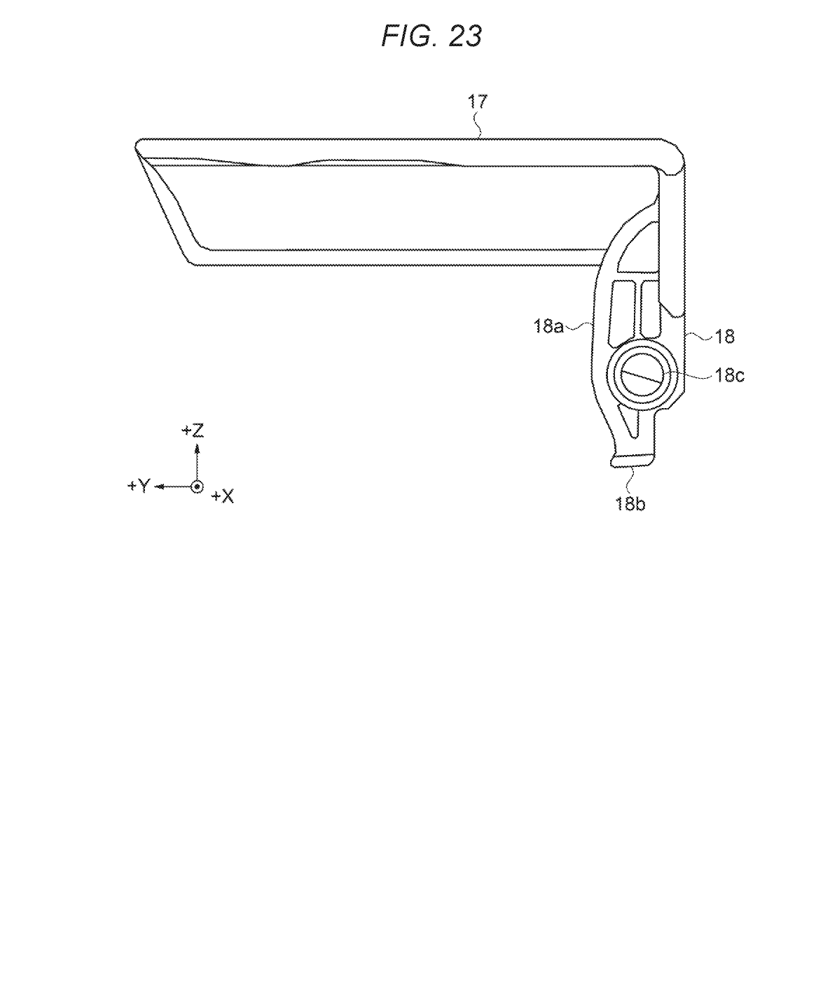

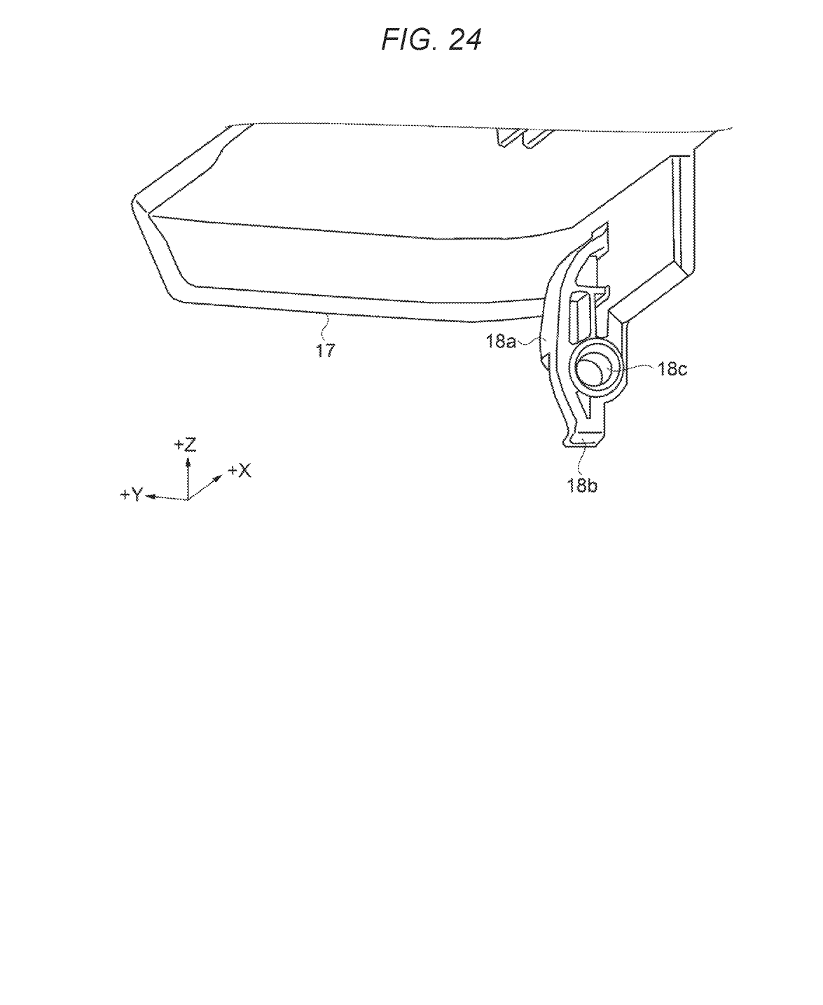

FIGS. 22, 23, and 24 show a schematic configuration of the supply path cover 17. FIGS. 23 and 24 show a part of the supply path cover 17 in an enlarged manner. FIG. 22 is a perspective view of the supply path cover 17 as viewed from the -Z direction. FIG. 23 is a cross-sectional view of the part of the supply path cover 17 as viewed from the +X direction. FIG. 24 is a perspective view of the part of the supply path cover 17 as viewed from the -Z direction.

The supply path cover 17 is provided with an engaging member 18. The engaging member 18 corresponds to an example of an abutted portion. The engaging member 18 abuts the pressing portion 29p. When the engaging member 18 and the pressing portion 29p abut each other, the supply path cover 17 moves from the first position P1 to the second position P2. The engaging member 18 includes an abutting surface 18a, a locking surface 18b, and a bearing portion 18c.

The abutting surface 18a is a surface that contacts the pressing portion 29p. When the image reading unit 13 changes from the shielded state CS to the open state OS by the user operation, the pressing portion 29p abuts a different position on the abutting surface 18a according to the change. A pivot position of the supply path cover 17 varies according to the position of the pressing portion 29p on the abutting surface 18a.

The locking surface 18b is a surface that abuts the image reading unit support base 29. The locking surface 18b restricts the pivot of the image reading unit 13 by abutting the image reading unit support base 29. When the locking surface 18b abuts the image reading unit support base 29, the image reading unit 13 stops in the open state OS.

The bearing portion 18c pivotally supports the supply path cover pivot shaft 17R. The engaging member 18 pivots about the supply path cover pivot shaft 17R pivotally supported by the bearing portion 18c. When the engaging member 18 pivots, the supply path cover 17 provided with the engaging member 18 pivots about the supply path cover pivot shaft 17R.

The engaging member 18 may be integrally formed with the supply path cover 17 or may be formed separately. The engaging member 18 is preferably formed integrally with the supply path cover 17. When the engaging member 18 is integrally formed with the supply path cover 17, the occurrence of the pivot failure of the supply path cover 17 during pivot of the supply path cover 17 is reduced.

The image reading unit 13 includes the image reading unit housing 27 that supports the document table 23. It is preferable that the pressing portion 29p is integrally formed with the image reading unit housing 27, and the engaging member 18 is integrally formed with the supply path cover 17.

The pivot failure of the supply path cover 17 is less likely to occur when either the image reading unit 13 or the supply path cover 17 pivots.

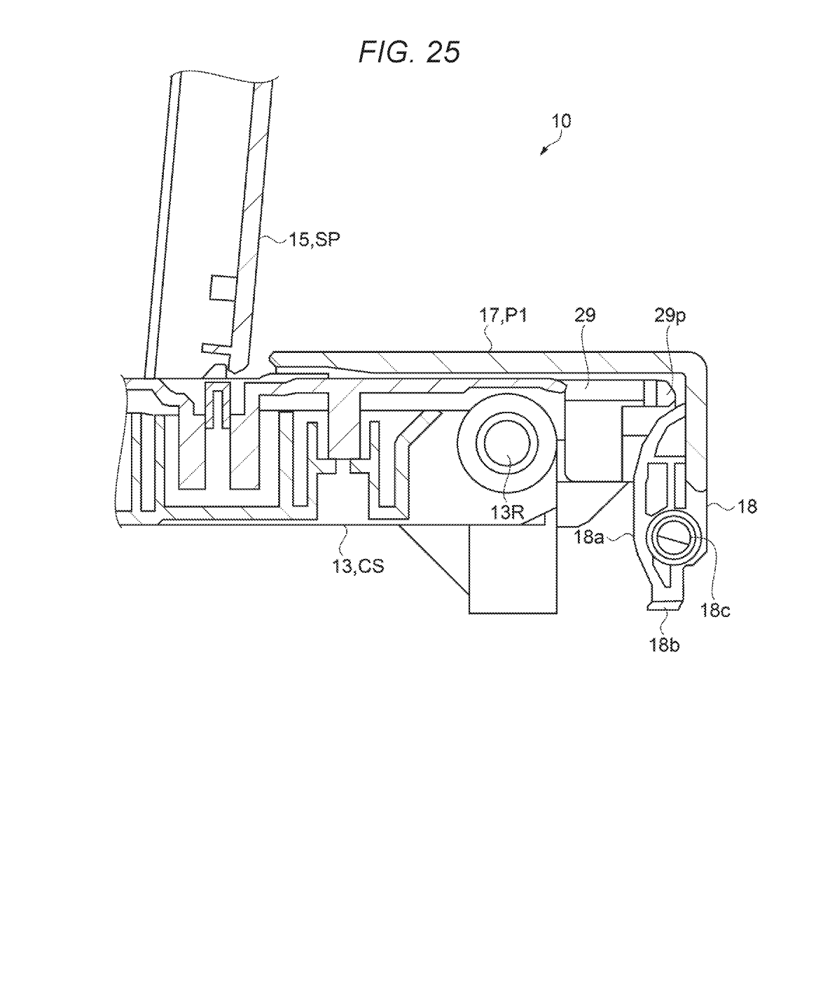

FIGS. 25, 26, and 27 show a schematic configuration of the printer 10. FIGS. 25, 26, and 27 show the vicinity of the supply path cover 17 in an enlarged manner. FIGS. 25, 26, and 27 show an operation of a mechanism by which the image reading unit 13 moves the supply path cover 17. FIGS. 25, 26, and 27 are cross-sectional views of the vicinity of the pressing portion 29p and the engaging member 18.

FIG. 25 shows the printer 10 of which the image reading unit 13 is in the shielded state CS and the supply path cover 17 is in the first position P1. FIG. 25 shows the document table cover 15 in the separation position SP. When the image reading unit 13 is in the shielded state CS and the supply path cover 17 is in the first position P1, the mechanism by which the image reading unit 13 moves the supply path cover 17 does not operate. The pressing portion 29p is located at a position facing the abutting surface 18a of the engaging member 18. The pressing portion 29p does not press the abutting surface 18a.

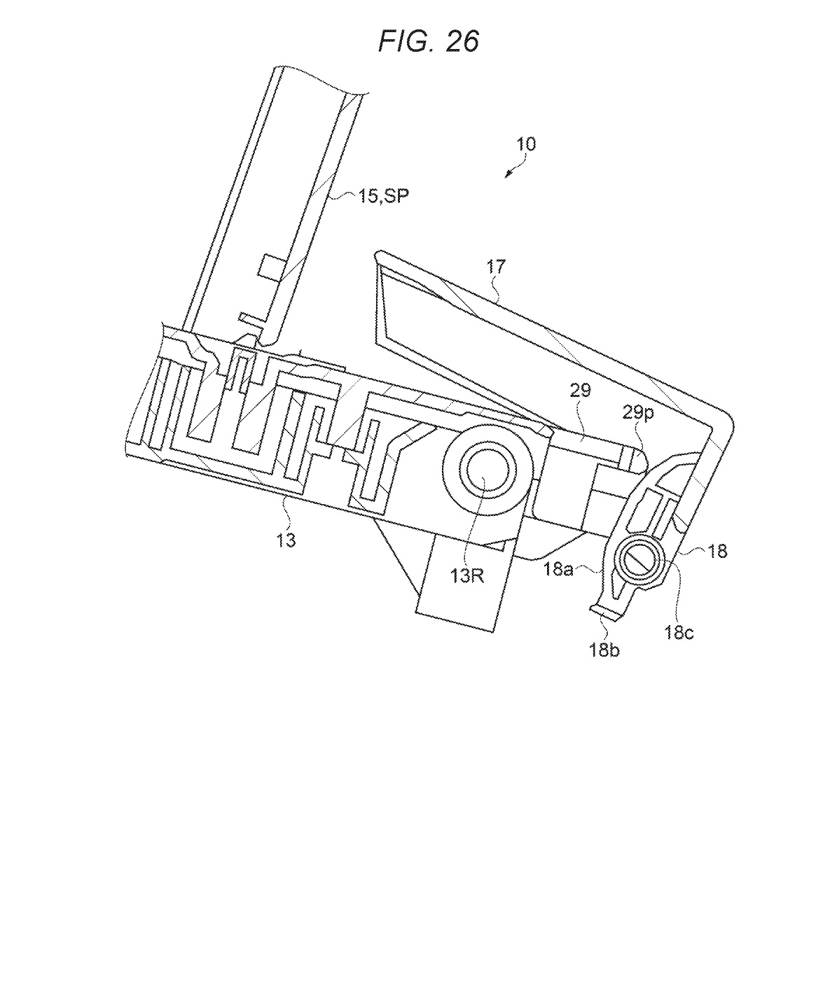

FIG. 26 shows the printer 10 of which the image reading unit 13 is in the middle of changing from the shielded state CS to the open state OS. FIG. 26 shows the document table cover 15 in the separation position SP.

While the image reading unit 13 is changing from the shielded state CS to the open state OS, the pressing portion 29p abuts the abutting surface 18a of the engaging member 18. A position where the pressing portion 29p and the abutting surface 18a of the engaging member 18 abut each other changes according to the change of the image reading unit 13 from the shielded state CS to the open state OS. The position where the pressing portion 29p and the abutting surface 18a of the engaging member 18 abut each other moves toward the locking surface 18b. In accordance with the movement of the position where the pressing portion 29p and the abutting surface 18a of the engaging member 18 abut each other, the supply path cover 17 pivots about the supply path cover pivot shaft 17R pivotally supported by the bearing portion 18c. The supply path cover 17 moves from the first position P1 toward the second position P2.

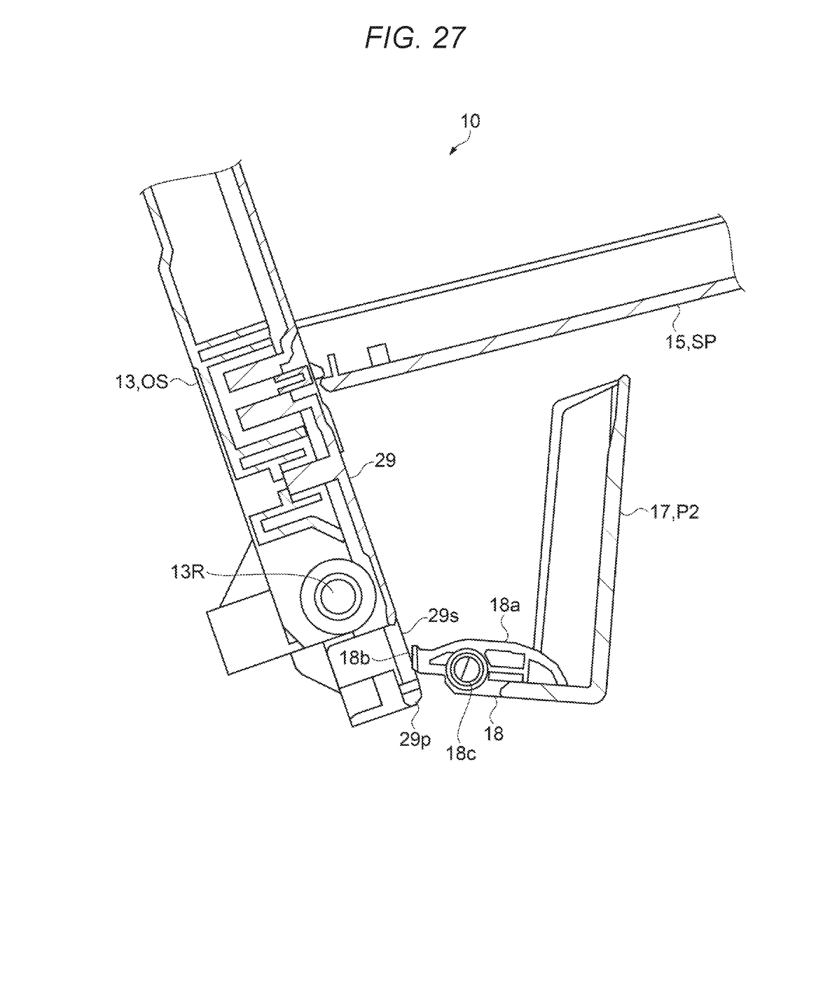

FIG. 27 shows the printer 10 of which the image reading unit 13 is in the open state OS. FIG. 27 shows the document table cover 15 in the separation position SP.

When the image reading unit 13 is in the open state OS, the pressing portion 29p does not abut the engaging member 18. The locking surface 18b of the engaging member 18 abuts a base surface 29s of the image reading unit support base 29. The base surface 29s is a surface of the image reading unit support base 29 in the +Z direction when the image reading unit 13 is in the shielded state CS. When the locking surface 18b abuts the base surface 29s, the supply path cover 17 is in the second position P2. When the locking surface 18b abuts the base surface 29s, the engaging member 18 restricts the pivot of the image reading unit 13 and stops the image reading unit 13 in the open state OS. The image reading unit 13 stops in the open state OS. In the printer 10, the image reading unit 13 and the supply path cover 17 are caused to pivot in conjunction with each other using the pressing portion 29p and the engaging member 18. In the printer 10, the image reading unit 13 and the supply path cover 17 can be caused to pivot in conjunction with each other with a simple mechanism.

FIGS. 25, 26, and 27 show the document table cover 15 in the separation position SP. The mechanism by which the image reading unit 13 moves the supply path cover 17 is not affected by the position of the document table cover 15. When the document table cover 15 is in the contact position CP, the image reading unit 13 and the supply path cover 17 pivot in conjunction with each other.

The printer 10 includes the recording head 62 configured to perform printing on a medium, the printer case 11 accommodating the recording head 62, the image reading unit 13 including the document table 23 on which a document is to be placed and pivotable about the image reading unit pivot shaft 13R between the shielded state CS of having the printer case 11 closed and the open state OS having the printer case 11 open, the second conveyance path 33 provided in the printer case 11 and configured to allow the medium to be conveyed from the supply port 51 formed in the printer case 11 to the printing position P facing the recording head 62, and the supply path cover 17 pivotable about the supply path cover pivot shaft 17R with respect to the printer case 11 between the first position P1 where the supply port 51 is closed and the second position P2 where the supply port 51 is opened. The supply port 51 is provided in the -Y direction of the document table 23 in a plan view from the +Z direction. The image reading unit pivot shaft 13R and the supply path cover pivot shaft 17R extend along the X axis intersecting the -Y direction. The supply path cover pivot shaft 17R is located in the -Y direction of the image reading unit pivot shaft 13R. When the image reading unit 13 is in the shielded state CS and the supply path cover 17 is in the first position P1, a part of the supply path cover 17 overlaps the image reading unit upper surface 13s. When the image reading unit 13 is changed from the shielded state CS to the open state OS, the pressing portion 29p provided at the image reading unit 13 abuts the engaging member 18 provided at the supply path cover 17, whereby the supply path cover 17 moves from the first position P1 to the second position P2.

In the printer 10, the image reading unit 13 and the supply path cover 17 can be caused to pivot in conjunction with each other with a simple mechanism.

What is claimed is:

1. A printing apparatus comprising:
a print head configured to perform printing on a medium;
a main body case accommodating the print head;
a scanner unit including a document placement table on which a document is to be placed, the scanner unit being pivotable about a first pivot shaft between a closed state of having the main body case closed and an open state of having the main body case open;
a conveyance path provided in the main body case and configured to allow the medium to be conveyed from a medium supply port formed in the main body case to a facing position facing the print head; and
a supply port cover pivotable about a second pivot shaft with respect to the main body case between a closing position where the medium supply port is closed and an opening position where the medium supply port is opened; wherein
the medium supply port is provided in a first direction of the document placement table in a plan view,
the first pivot shaft and the second pivot shaft extend along an intersecting axis intersecting the first direction,
the second pivot shaft is located in the first direction of the first pivot shaft,
when the scanner unit is in the closed state and the supply port cover is in the closing position, a part of the supply port cover overlaps an upper surface of the scanner unit, and
when the scanner unit is changed from the closed state to the open state, an abutting portion provided at the scanner unit abuts an abutted portion provided at the supply port cover, whereby the supply port cover moves from the closing position to the opening position.

2. The printing apparatus according to claim 1, wherein
the scanner unit includes a scanner housing that supports the document placement table,
the abutting portion is integrally formed with the scanner housing, and
the abutted portion is integrally formed with the supply port cover.

3. The printing apparatus according to claim 1, wherein
the scanner unit includes a document cover pivotable about a third pivot shaft between a shielding position where the document placement table is covered and an opening position where the document placement table is open,
the third pivot shaft extends along the intersecting axis and is located in a second direction of the first pivot shaft, the second direction being opposite to the first direction, and
the supply port cover is provided in the first direction of the document cover in the plan view.

4. The printing apparatus according to claim 3, wherein
when the scanner unit is in the open state and the document cover is in the opening position, the supply port cover in the opening position is configured to abut the document cover.

5. The printing apparatus according to claim 3, wherein
a supply port cover upper surface of the supply port cover in the closing position and a document cover upper surface of the document cover in the shielding position are located on a same plane.

6. The printing apparatus according to claim 3, wherein
a supply port cover end portion in the second direction of the supply port cover in the closing position and a document cover end portion in the first direction of the document cover in the shielding position are in contact with each other.
